(19) United States
(12) Patent Application Publication
(10) Pub. No.: US 2011/0029324 A1
(43) Pub. Date: Feb. 3, 2011

(54) Project management system, project management center device used for the same, terminal device, project management center device program, terminal device program, and electronic medical record management system

(75) Inventors: Yoshiaki Kondo, Miyagi (JP); Masatoshi Tate, Miyagi-ken (JP)

Correspondence Address: THE NATH LAW GROUP, 112 South West Street, Alexandria, VA, 22314, US

(73) Assignees: WISE SOLUTIONS INC., Sendai-shi (JP); Yoshiaki KONDO, Sendai-shi (JP)

(21) Appl. No.: 12/309,242

(22) PCT Filed: May 16, 2007
(86) PCT No.: PCT/JP2007/060048

§ 371 Date: Oct. 29, 2009

(30) Foreign Application Priority Data
Jul. 13, 2006 (JP) 2006-193204

(51) Int. Cl. G06Q 50/00; G06Q 10/00

(52) U.S. Cl. 705/3

(57) ABSTRACT

It is possible to provide a project management system and a project management system program for supporting effective building and management of a project by considering relationship among actions executed in a project management. For example, an electronic medical report system (1) includes an electronic medical record management center device (10) for managing information on a medical action executed on a medical site which device is connected via a network (30) to a plurality of terminal devices (20) used by users. The electronic medical record management center device (10) has linkage information for linking to other medical action for each of the medical actions. The terminal devices (20) generate electronic medical records by considering the relationship among the medical actions according to the linkage information.

### TECHNICAL FIELD

The present invention relates to a project management system, a project management center device used for the same, a terminal device, a project management center device program, a terminal device program, and an electronic medical record management system, for managing project in various fields.

### BACKGROUND ART

Conventionally, applications for managing projects have been developed and used in various fields.

In this situation, treatment plans for patients are managed by using an electronic medical record in a medical site.

While there is the advantage that this electronic medical record takes up less storage space of data than a medical record described on paper does, the treatment plan inputted is planned with the medical doctor's judgment, and there are dependence to the medical doctor's decision and skill as well as the case where the medical record of paper is used, much.

Therefore, the problem, which is a possibility that there may be a part from which the treatment plan differs for every medical doctor, or inefficient treatment may be performed, remains.

In particular, in recent years, since the medical technology has developed and become complicated, it is becoming difficult to plan the best treatment only by the medical doctor's judgment.

In order to provide efficient treatment, solving this problem and ensuring the medical quality, a tool for summarizing medical information called the clinical pathway to the schedule is developed, as shown in Japanese Patent Application Laid-open Publication No. 2003-108661.

This clinical pathway standardizes a hospitalization and a treatment schedule according to each illness, and summarizes a schedule of a treatment, an inspection, an instruction, an inspection, etc. for a patient with a certain disease along with the time-line.

By introducing the clinical path, there is the advantage that the medical doctor can grasp the treatment plan efficiently, and this treatment plan of information in regard of the treatment can be shared with medical staffs, such as nurse, and the medical progression in quality can be achieved.

Moreover, according to a technology described in Japanese Patent Publication No. 2706645 and Japanese Patent Publication No. 2815346, variety of information about the already performed medical action and the medical action performed in the future can be stored for every date or every date and every time, and these varieties of information can be displayed on the table which arranged on every date or the time-line.

By using this technology, the variety of information about the patient can understand at a glance, and also the information in regard of treatment can be shared with the medical staff, each medical staff can input the data, etc., and the treatment plan can be suitably changed based on these.

### DISCLOSURE OF THE INVENTION

However, these arranged medical actions are not the information which has the meaning only by the action individual in fact. Since these arranged medical actions are performed in many cases by being subordinately and exclusively relevant with other actions based on the time-line, for example when performing by being subordinate to a treatment and a medicine which are performed and prescribed in the past for the patient, or when the medicine prescribed for the patient is limited only in predetermined time hereinafter by performing the medical action, these information acts as an important element in the treatment.

According to the technology of Japanese Patent Application Laid-open Publication No. 2003-108661, Japanese Patent Publication No. 2706645, and Japanese Patent Publication No. 2815346, although each medical action could be displayed on the time-line and the information on the treatment plan could be shared among the medical staff, there is a problem that it is not taken into consideration about the mutual relationship of each medical action mentioned above.

Also this problem is the same in other project management systems, and not only inputting each of the action information which comprises the project but the mutual relation of each of the action information is important. Higher-precision project management can be performed by judging that it is effective for a plurality of inputted action information to perform together mutually or it is effective not to perform together.

However, in the conventional project management system, the action information of the different kind is independently programmed such as a program about the performed project management and a program about accounting management. Since it had to execute with the program level to define the mutual relation of these information, it is difficult for the end user to perform.

Therefore, the object of the present invention is to provide a project management system, a project management center device used for the same, a terminal device, a project management center device program, a terminal device program, and an electronic medical record management system, for supporting building and management of a project efficiently in consideration of a mutual relationship of an action performed in a project management.

In the project management system, the project management center device used for the same, the terminal device, the project management center device program, the terminal device program, and the electronic medical record management system of the present invention, all the information which comprises the project is built with the common structure which has the time information, respectively.

When glancing, even if it is the information which may be visible to the information on the different kind, all the information about the action includes the information about time. For example, in the medical field, the information about the time whether there being the current allergy or the past had allergy is included in the information about allergy, and the information about the time of being the contraindication toward when the medicine taken (before what day or before how many hours) is included in the information about the medicinal formula.

In the present invention, the mutual relation of each of the action information can be defined by building each of the action information which comprises the project with the structure having a common parameter based on this time information. If it is the medical field, relation can be mutually detected among all actions, such as medical care, the medicinal formula, accounting management, and staff assignment of the nurse, hospitalization management, and food services, and the project management can be performed ubiquitously.

A project management system of the present invention according to claim 1 is a project management system for managing act information in a project on time-line, characterized by comprising: an act information storage unit configured to store a plurality of act information which includes at least linkage information which comprises an applicable condition for an own act and other acts to have a relevance for the every performed act; an act information acquiring unit configured to acquire the act information which is selected from the plurality of act information stored in the act information storage unit; an act information arrangement unit configured to arrange the act information on the time-line information based on direction from the outside, respectively, wherein the act information has time-line information and the act information is acquired by the act information acquiring unit; an act information detecting unit configured to detect mutually other act information to which the linkage information included in the act information concerned is applied, among the act information arranged by the act information arrangement unit on the time-line information; and an output information generation unit configured to output information is generated based on a resulting detection processing in the act information detecting unit.

Moreover, a project management system according to claim 2 is the project management system according to claim 1, characterized in that: the act information stored in the act information storage unit further includes self-act information which comprises self-act characteristic information and self-act logic information, wherein the self-act characteristic information comprises information about characteristics of the act itself, wherein the self-act logic information comprises an applicable condition for processing generated based on this self-act characteristic information; and the output information generation unit generates the output information based on the self-act characteristic information, when the applicable condition of the self-act logic information of the act information arranged on the time-line information is applied.

Moreover, a project management system according to claim 3 is the project management system according to claim 1 or 2, characterized in that: the act information stored in the act information storage unit further includes generation control information to control generation order and generation conditions at the time of the output information being generated in the output information generation unit; and the output information processing unit executes the generation processing on the generation order and generation conditions, wherein the generation order and generation conditions are controlled based on the generation processing control information.

Moreover, a project management system according to claim 4 is the project management system according to any one of claims 1 to 3, characterized in that contents of the output information generation processing in the output information processing unit include at least one of adding of information on other acts, deletion of information on the act already arranged, generation of warning information, and generation of pertinent information inspection screen.

Moreover, a project management system according to claim 5 is the project management system according to any one of claims 1 to 4, characterized in that the act in the project is at least one of a medical action, a staff management action, needed procurement-of-supplies-and-equipment act, and accounting implementation act.

Moreover, a project management center device according to claim 6 is a project management center device for managing information about an act performed in a project, characterized by comprising: an act information storage unit configured to store a plurality of act information which includes at least linkage information which comprises an applicable condition for an own act and other acts to have a relevance for every performed act; and a project information record unit configured to store project information created with arranging the act information on time-line information.

Moreover, a project management center device according to claim 7 is the project management center device according to claim 6, characterized in that the act information stored in the act information storage unit further includes self-act information which comprises self-act characteristic information and self-act logic information, wherein the self-act characteristic information comprises information about characteristics of the act itself, wherein the self-act logic information comprises an applicable condition for processing generated based on this self-act characteristic information.

Moreover, a project management center device according to claim 8 is the project management center device according to claim 6, characterized in that the act information stored in the act information storage unit further includes generation processing control information to control generation order and generation conditions of a plurality of output information, wherein the output information includes at least one of output information generated based on a result from which other act information to which the linkage information is applied is detected among the act information arranged at the time-line information, and output information generated based on the self-act characteristic information when an applicable condition of the self-act logic information of the act information arranged at the time-line information is applied.

Moreover, a terminal device according to claim 9 is a terminal device connected to a project management center device for managing project information about an act performed in a project through a network, the terminal device being used by a user, characterized by comprising: an act information acquiring unit configured to acquire selected act information through the network from a plurality of act information, wherein the plurality of act information is stored on the project management center device and includes at least linkage information which comprises applicable conditions for an own act and other acts to have a relevance for every performed act; an act information arrangement unit configured to arrange the act information on the time-line information based on direction from the outside, respectively, wherein the act information has time-line information and the act information is acquired by the act information acquiring unit; an act information detecting unit configured to detect mutually other act information to which the linkage information included in the act information is applied, among the concerned act information arranged by the act information arrangement unit on the time-line information; and an output information generation unit configured to output information is generated based on a resulting detection processing in the act information detecting unit.

Moreover, a terminal device according to claim 10 is the terminal device according to claim 9, characterized in that: the act information acquired by the act information acquiring unit further includes self-act information which comprises self-act characteristic information and self-act logic information, wherein the self-act characteristic information comprises information about characteristics of the act itself, wherein the self-act logic information comprises an applicable condition for processing generated based on this self-act characteristic information; and the output information generation unit generates the output information based on the self-act characteristic information, when the applicable condition of the self-act logic information of the act information arranged on the time-line information is applied.

Moreover, a terminal device according to claim 11 is the terminal device according to claim 9 or 10, characterized in that: the act information acquired in the act information acquiring unit further includes generation control information to control generation order and generation conditions at the time of the output information being generated in the output information generation unit; and the output information processing unit executes the generation processing on the generation order and generation conditions, wherein the generation order and generation conditions are controlled based on the generation processing control information.

Moreover, a terminal device according to claim 12 is the terminal device according to any one of claims 9 to 11, characterized in that contents of the output information generation processing in the output information processing unit include at least one of adding of information on other acts, deletion of information on the act already arranged, generation of warning information, and generation of pertinent information inspection screen.

Moreover, a terminal device according to claim 13 is the terminal device according to any one of claims 9 to 12, characterized in that the act in the project is at least one of a medical action, a staff management action, needed procurement-of-supplies-and-equipment act, and accounting implementation act.

Moreover, a terminal device according to claim 14 is the terminal device according to any one of claims 9 to 13, characterized by further comprising a temporary storage unit configured to store project information which the act information is arranged and is comprised on the time-line information.

Moreover, a project management center device program according to claim 15 is a project management center device program for achieving a plurality of functions to a project management center device for managing project information about an act performed in a project, characterized by comprising: an act information memory function for storing a plurality of act information which includes at least linkage information which comprises applicable conditions for an own act and other acts to have a relevance for every performed act; and a project storing function for storing the project information created with arranging which the act information the time-line.

Moreover, a terminal device program according to claim 16 is a terminal device program for achieving a plurality of functions to a terminal device connected to a project management center device for managing information of an act performed in a project through a network, the terminal device is used by a user, characterized by comprising: an act information acquisition function for acquiring selected act information through the network from a plurality of act information, wherein the plurality of act information is stored on the project management center device and includes at least linkage information which comprises applicable conditions for an own act and other acts to have a relevance for every performed act; an act information arrangement function for arranging the act information on the time-ling information based on direction from the outside, respectively, wherein the act information has time-line information and the act information is acquired by the act information acquisition function; an act information detection function for detecting mutually other act information to which the linkage information included in the concerned act information is applied among the act information arranged by the information arrangement function on the time-line information; and an output information generation function for generating output information based on a resulting detection processing by the act information detection function.

Moreover, a terminal device program according to claim 17 is the terminal device program according to claim 16, characterized in that: the act information acquired by the act information acquiring function further includes self-act information which comprises self-act characteristic information and self-act logic information, wherein the self-act characteristic information comprises information about characteristics of the act itself, wherein the self-act logic information comprises an applicable condition for processing generated based on this self-act characteristic information; and the output information generation function generates the output information based on the self-act characteristic information, when the applicable condition of the self-act logic information of the act information arranged on the time-line information is applied.

Moreover, a terminal device program according to claim 18 is the terminal device program according to claim 16 or 17, characterized in that: the act information acquired in the act information acquiring function further includes generation control information to control generation order and generation conditions at the time of the output information being generated in the output information generation function; and the output information processing function executes the generation processing on the generation order and generation conditions, wherein the generation order and generation conditions are controlled based on the generation processing control information.

Moreover, a terminal device program according to claim 19 is the terminal device program according to any one of claims 16 to 18, characterized in that contents of the output information generation processing in the output information processing function include at least one of adding of information on other acts, deletion of information on the act already arranged, generation of warning information, and generation of pertinent information inspection screen.

Moreover, a terminal device program according to claim 20 is the terminal device program according to any one of claims 16 to 19, characterized in that the act in the project is at least one of a medical action, a staff management action, needed procurement-of-supplies-and-equipment act, and accounting implementation act.

Moreover, a terminal device program according to claim 21 is the terminal device program according to any one of claims 16 to 20, characterized by further comprising a temporary storage function configured to store project information which the act information is arranged and is comprises on the time-line information.

Moreover, an electronic medical record management system according to claim 22 is an electronic medical record management system for managing information about a medical action on time-line, characterized by comprising: a medical action information storage unit configured to store a plurality of medical action information which includes at least linkage information which comprises applicable conditions for an own medical action and other medical actions to have a relevance is recorded for every medical action; a medical action information acquisition unit configured to acquire the medical action information which is selected from a plurality of the medical action information stored in the medical action information storage unit; a medical action arrangement unit configured to arrange the medical action information on the time-axis information based on direction from the outside, respectively, wherein the act information has time-line information and the act information is acquired by the medical action information acquisition unit; a medical action information detecting unit configured to detect mutually other medical action information that the linkage information included in the concerned medical action information is applied, among the medical action information arranged by the medical action arrangement unit on the time-line information; and an output information generation unit configured to output information is generated based on a resulting to which detection processing in the medical action information detecting unit.

Therefore, according to the project management system, the project management center device used for the same, the terminal device, the project management center device program, the terminal device program, and the electronic medical record management system of the present invention, the building and the management of the project are efficiently supportable in consideration of the mutual relationship of the action performed in the project management.

### BRIEF DESCRIPTION OF THE DRAWINGS

FIG. 1 It is a block diagram showing a configuration of an electronic medical record management system as a project management system according to a first embodiment of the present invention.

FIG. 2 It is an explanatory diagram showing a structure of COA used with the project management system according to the first embodiment and a third embodiment of the present invention.

FIG. 3 It is an explanatory diagram showing a position of information of COA on the time-line of a project management system according to the first embodiment and the third embodiment of the present invention.

FIG. 4 It is a flow chart showing an operation of the electronic medical record management system as the project management system according to the first embodiment of the present invention.

FIG. 5 It is an explanatory diagram showing a position of information of a plurality of COA(s) located on the time-line of the electronic medical record management system as the project management system according to the first embodiment of the present invention.

FIG. 6 It is an explanatory diagram showing a relationship among the information of COA(s) used with the project management system according to the first embodiment, the third embodiment, and a fourth embodiment of the present invention.

FIG. 7 It is an explanatory diagram showing a relationship among the information of COA(s) used with the project management system according to the second embodiment of the present invention.

FIG. 8 It is an explanatory diagram showing a position of the information of a plurality of COA(s) located on the time-line of the electronic medical record management system as the project management system according to the third embodiment of the present invention.

FIG. 9 It is a block diagram showing a configuration of a fabricating process management system as the project management system according to the fourth embodiment of the present invention.

FIG. 10 It is a flow chart showing an operation of the fabricating process management system as the project management system according to the fourth embodiment of the present invention.

FIG. 11 It is an explanatory diagram showing a position of the information on a plurality of COA(s) located on the time-line of the fabricating process management system as the project management system according to the fourth embodiment of the present invention.

### DESCRIPTION OF THE PREFERRED EMBODIMENT(S)

### An Electronic Medical Record Management System as a First Embodiment of a Project Management System

An electronic medical record management system for managing a treatment plan in a medical field as a first embodiment of a project management system of the present invention will be explained.

### <Basic Concept>

In the electronic medical record management system of this embodiment, various kinds of medical actions are individually defined and are managed as an “act”.

And each acts of these have the information which is the Core of Act (hereinafter, referred to “COA”). In this COA, the relationship with other acts defined based on the time-line, respectively, etc. are stored.

As a kind of act, there are “observation”, “formula”, “injection”, “supply of food”, etc. There is information related to other medical actions based on the time-line of having to “observe” after predetermined time passage after “injection”, individually, etc.

The information except the medical action, including for example, information of the “symptom”, etc., is also the COA generated based on the act “observation”, and this information (symptom) is held as the COA of “observation”. Moreover, “age”, “sex”, etc. are COA(s) generated as a result of the act “observation”, and each patient by whom the electronic medical record is created is regarded as an aggregate of a plurality of COA(s).

That is, all the information is held as the COA of a certain medical action (act).

Based on such a concept, in the electronic medical record management system of this embodiment, the COA(s) which has the information based on the time-axis individually are made to link in the data structure which already has a time-line called the electronic medical record, and a management of high-precision medical information is supported.

### <Configuration of the Electronic Medical Record Management System as the First Embodiment>

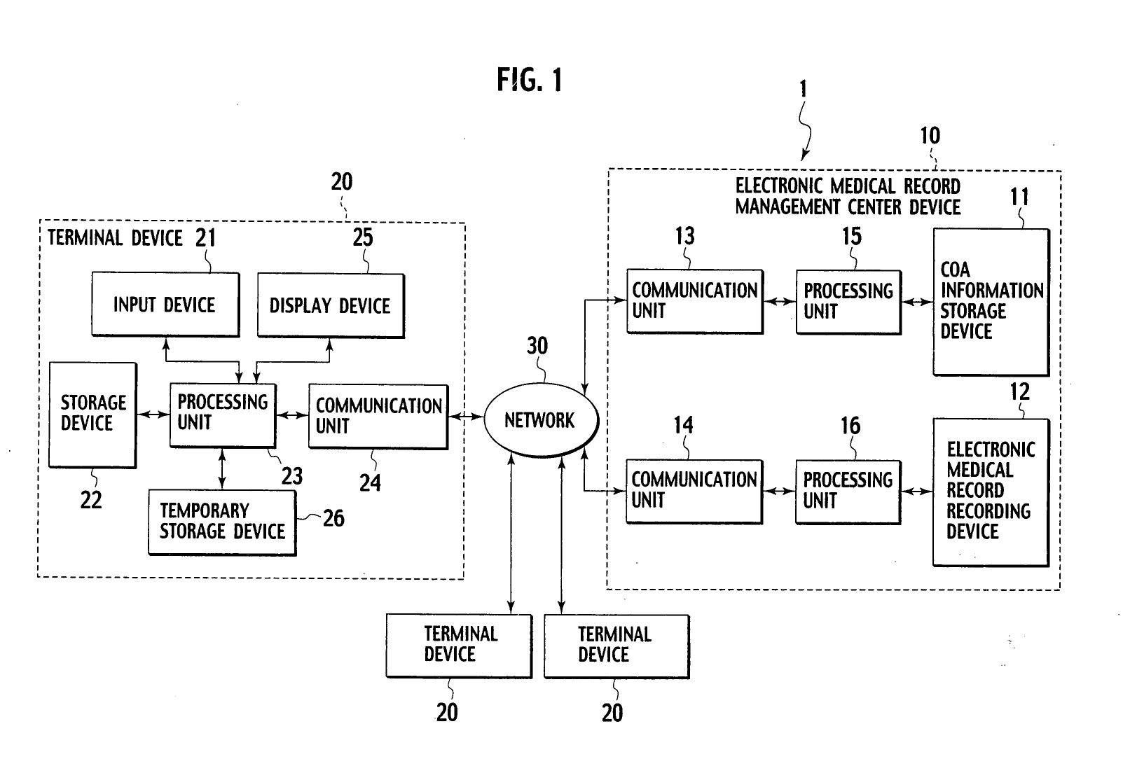

A configuration of an electronic medical record management system 1 according to this embodiment will be explained with reference to FIG. 1.

The electronic medical record management system 1 according to this embodiment is comprised by connecting an electronic medical record management center device 10 as a project management center device, and a plurality of terminal devices 20, through a network 30.

### [Electronic Medical Record Management Center 10]

The electronic medical record management center device 10 includes: a COA information storage device 11 as act information memory means; an electronic medical record recording device 12 as project recording means; a communication unit 13 and a communication unit 14 for communicating the external terminal device 20 through the network 30; a processing unit 15 for acquiring data from the COA information storage device 11; and a processing unit 16 for executing an processing which acquires data from the electronic medical record recording device 12, and recording on the electronic medical record recording device 12.

COA about the various acts inputted beforehand is stored in the COA information storage device 11.

The electronic medical record recording device 12 records data generated as an electronic medical record by using the COA.

The processing unit 15 reads data from the COA information storage device 11 according to an request acquired from the terminal device 20 through the communication unit 13, and outputs to the terminal device 20 through the communication unit 14.

The processing unit 16 reads data from the electronic medical record recording device 12 according to a request acquired from the terminal device 20 through the communication unit 14, and outputs them to the terminal device 20 through the communication unit 14. Moreover, the electronic medical record data acquired from the terminal device 20 through the communication unit 14 is made to record on the electronic medical record recording device 12.

### —Configuration of COA—

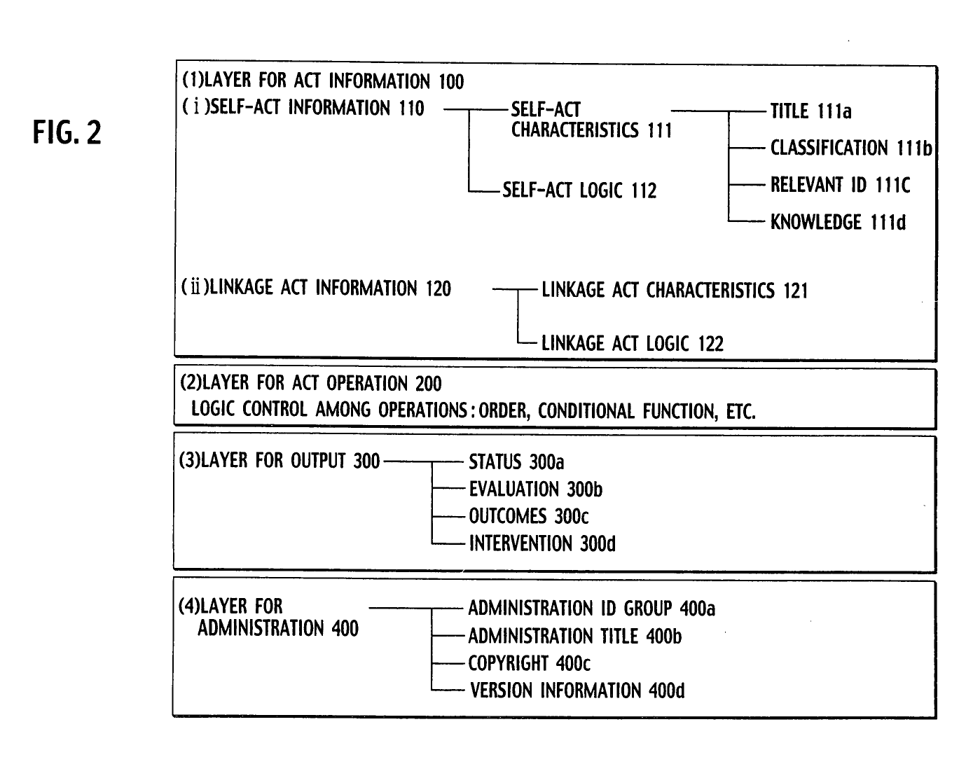

The information which comprises each COA stored in the COA information storage device 11 will be explained with reference to FIG. 2.

Each COA has (1) layer for act information 100, (2) act operation layer 200, (3) layer for output 300, and (4) layer for administration 400.

### (1) Layer for Act Information 100

The layer for act information 100 includes (i) self-act information 110 as self-act information which is information about the self act, and (ii) linkage act information 120 as linkage information which is information for linking with other COA(s).

### (i) Self-Act Information 110

The self-act information 110 further includes self-act characteristics 111 as self-act characteristic information, and a self-act logic 112 as self-act logic information. A title 111a (an official title, an another title, a temporary title, etc.), a classification 111b (a main class, a sub class, a minor class, etc.), a relevant ID 111c (discrimination ID for linking to other COA the corresponding to the title 111a), and knowledge 111d (quantity, speed, a unit, scientific knowledge and know-how about the self-act, etc.) of the self act are stored in the self-act characteristics 111.

As an example of the classification 111b, there are “operation act” and “logical act” as the main class, and there are “observational act” and “interventional act” as the sub class of the “operation act”. Moreover, there are “clinical history”, “symptom”, “finding”, etc. as the minor class of the “observational act”, and there are the “laboratory test”, “image inspection”, “physiology inspection”, “formula”, “injection”, “treatment”, “admission and discharge”, “supply of food”, etc. as the minor class of the “interventional act”. Moreover, there are “data generation by the combination of the inspection result”, “generation of the prescription; product chit”, etc. as the minor class of the “logical act”.

In the self-act logic 112, the information, including a calculating method of the quantity, an appropriate range of the dose, a valuation method of the symptom, unitary conversion, a method of presentation, etc., is stored at the time of performing the self act.

### (ii) Linkage Act Information 120

The linkage act information 120 includes linkage act characteristics 121 and linkage act logic 122. In the linkage act characteristics 121, the information of other COA(s) which have the relevance is stored. In the linkage act logic 122, a conditional function and a logic flaw, etc. by logical OR and logical AND etc., which shows the valid time and the scope at the time of linking with other COA(s) based on the information of the linkage act characteristics 121 are stored.

### (2) Act Operation Layer 200

In the act operation layer 200, logic control information among the operations at the time of processing based on the self-act logic 112 and the linkage act logic 122, for example, the execution sequence, the conditional function, etc., are stored.

### (3) Layer for Output 300

In the layer for output 300, the information, including a status 300a about the operation of self COA (an assumption, a plan, an operation decision, a preparation, an implementation, a result, etc.), an evaluation 300b (success, failure, etc.), outcomes 300c (an observation result, an executed result, definition as a graphic, chit and prescription generation, etc.), intervention 300d toward other COA(s), etc., is stored.

### (4) Layer for Administration 400

In the layer for administration 400, an administration ID group 400a for managing each COA, an administration title 400b, a copyright 400c which applies each COA as works, and version information 400d, such as writing time and the update date, are stored.

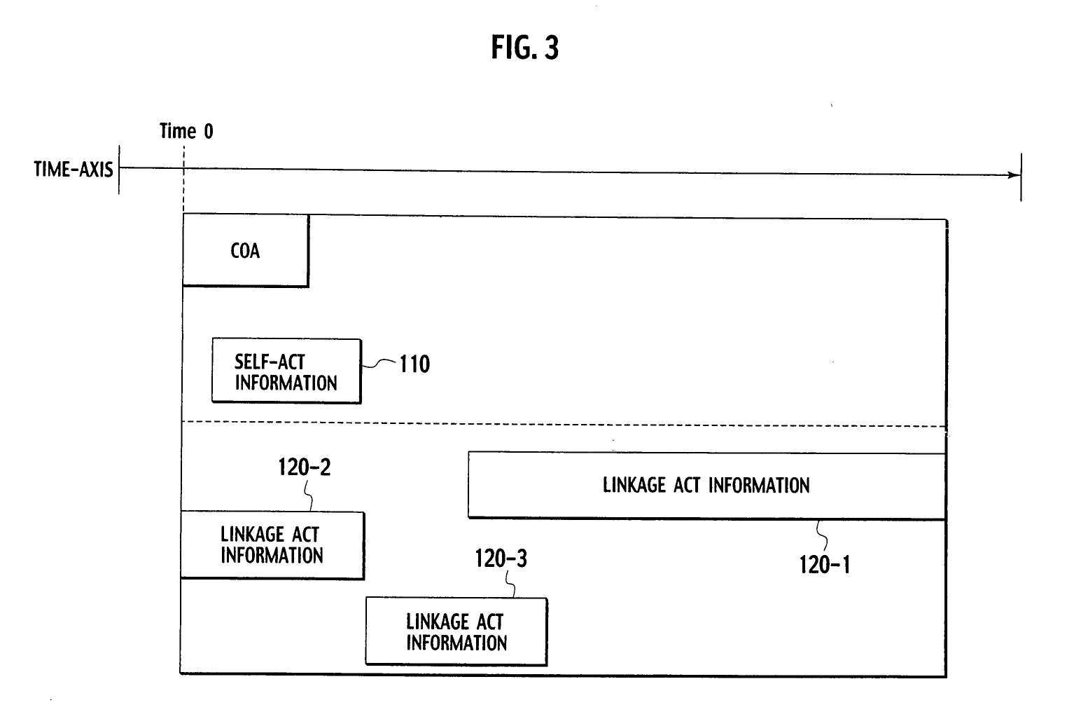

The scope of the information on the time-line of each COA is shown in FIG. 3. The COA can have a plurality of linkage act information 120 respectively. In the COA of FIG. 3, the COA has three linkage acts of the linkage act information 120-1 to 120-3.

In FIG. 3, the linkage act information 120-1 is the information applied of ter the predetermined time passage after executing medical action according to the self-act information 110. The linkage act information 120-2 is the information applied simultaneously with executing medical action according to the self-act information 110. The linkage act information 120-3 is the information applied from the time of the termination of the medical action according to the self-act information 110.

### [Terminal Device 20]

The terminal device 20 is used by the medical doctor, and includes: an input device 21 operated by the user; a storage device 22 for storing an application for using the electronic medical record management system; a processing unit 23 for executing creation, updating, etc. of the electronic medical record; a communication unit 24 for communicating with the electronic medical record management center 10 through the network; a display device 25 for displaying information during operation; and a temporary storage device 26 for storing information temporarily.

The input devices 21 are a mouse, a keyboard, etc., for example.

The storage device 22 comprises a ROM, for example.

The processing unit 23 acquires information currently recorded in the COA information storage device 11 or the electronic medical record recording device 12 of the electronic medical record management center device 10 through the communication unit 24, acquires an operator guidance from the input device 21, and performs the operation processing, such as contravention detection among the COAs, and the amount calculation of formulas.

The display device 25 is a monitor etc. connected to a personal computer which includes a mechanism of the storage device 22, the processing unit 23, the communication unit 24, and the temporary storage device 26, for example.

The temporary storage device 26 temporarily stores the information acquired from the electronic medical record management center device 10, and the information processed in the processing unit 23, and enables use of the electronic medical record in the restrictive range also in the environment which cannot use the network.

In the electronic medical record management system 1 comprised as mentioned above, since the subordinate and the exclusionary act information applied when each COA links with other COA(s) are stored based on the time-line information, the COA being inputted into the electronic medical record and the COA already inputted into the electronic medical record can be associated on the time-line. For example, it is possible to process not only the information on the contraindication by the combination of the mere medicine, etc. but the detailed analysis) whether to be the contraindication when inputting (timing).

### <Operation of Electronic Medical Record Management System as First Embodiment>

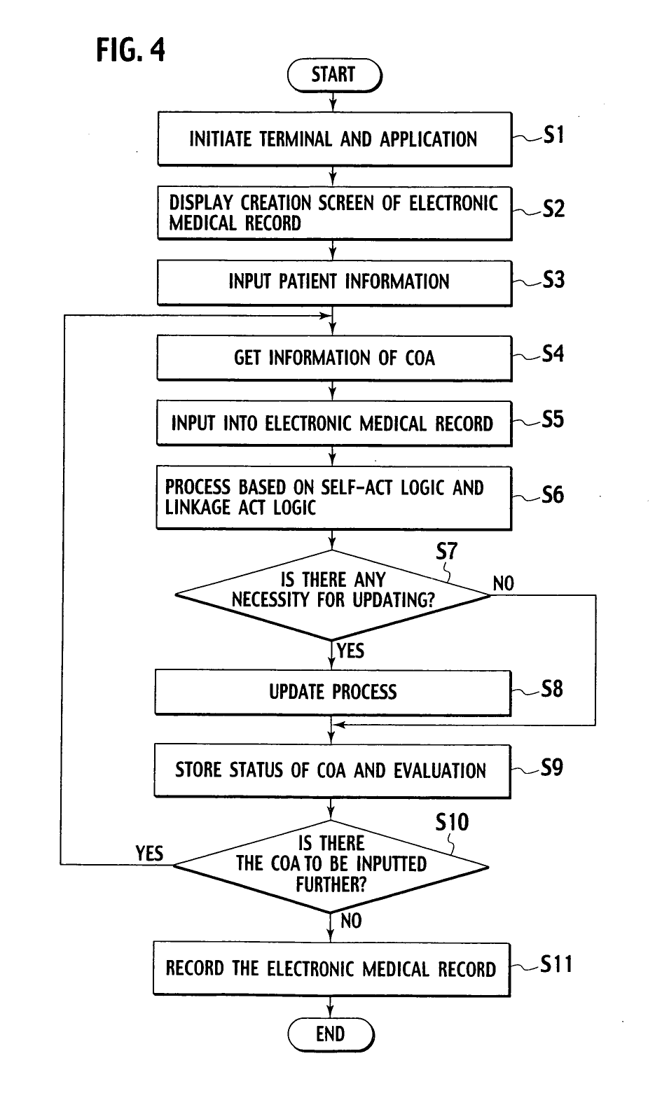

Hereinafter, with reference to FIG. 4 to FIG. 6, an operation of the electronic medical record management system 1 as the first embodiment will be explained in detail by using an example.

This embodiment will explain the operation of the electronic medical record management system 1 at the time of generating a treatment plan for the patient X (the 3 years-old boy, the 15 kg weight) with the acetonemic vomiting and dehydration to the example.

In creating the electronic medical record in this embodiment, the information of the layer for act information 100 of COA (A), COA (B), COA (C), and COA (D) is stored in the COA information storage device 11 of the electronic medical record management center device 10 as shown in Table 1, and the information of the layer for administration 400 is stored beforehand as shown in Table 2.

As for each information stored in these COA(s), the self-act information of COA (A) is expressed as the self-act information 110 (A), the linkage act information is expressed as the linkage act information 120 (A), . . . , the self-act information of COA (B) is expressed as the self-act information 110 (B), and linkage act information is expressed as the linkage act information 120 (B), respectively.

TABLE 1

| | | | |
|---|---|---|---|
| COA (A) | COA (B) | COA (C) | COA (D) |

(1) Act information layer 100
(i) Self-act 110

| | | | | | |
|---|---|---|---|---|---|
| Self-act | Title 111a | Glucose intravenous | Physiological saline | Emesis | Total sugar dose |
| characteristics 111 | | injection | intravenous drip infusion | | calculation |
| | Classification | Intervention operation | Intervention operation | Observation operation | Logic operation |
| | 111b | (Injection) | (Intravenous drip) | (Symptom) | (Inspection) |
| | Relevant ID 111c | I-00001 | D-00001 | O-00001 | L-00001 |
| | Knowledge 111d | Cautions for using to | Cautions for overdosing | Cause disease of emesis, | Formula of the sum total |
| | | diabetes mellitus, etc. | on NaCl, etc. | therapeutic method, etc. | (concentration × time) in |
| | | | | | each injection |

| | | | | |
|---|---|---|---|---|
| Self-act logic 112 | Calculation of the | Calculation of the | Stage valuation method of | Calculation of the sum |
| | concentration, | concentration, | the symptom, and logic | total (concentration × |
| | administration time, and | administration time, and | about the display, etc. | time) in each injection |
| | the total dose of the | the total dose of the | | |
| | self-parenteral solution, | self-parenteral solution, | | |
| | creation of the injection | creation of the injection | | |
| | chit output form, etc. | chit output form, etc. | | |

(ii) Linkage act 120

| | | | | |
|---|---|---|---|---|
| Linkage act characteristics 121 | Prohibition of glucose | Limitation of administration | Nothing | Nothing |
| | administration of each 2 | simultaneously with other | | |
| | hours before and after the | transfusion, etc. | | |
| | self-act | | | |
| Linkage act logic 122 | [Conditional function] | [Conditional function] | [Conditional function] | [Conditional function |

TABLE 2

| | COA (A) | COA (B) | COA (C) | COA (D) |
|---|---|---|---|---|
| Management title 400a | Injection processing | Injection processing | Observation of symptom | Generation of logic result |
| Management ID 400b | X0001A001 | X0001B001 | S0001A001 | R0001A001 |
| Copyright 400c | Hospital A | Hospital A | Medical doctor B | Publishing company C |
| Version information 400d | The 3^{rd} edition | The 5^{th} edition | The 3^{rd} edition | The 1^{st} edition |
| | Created on Mar. 2, 2004 | Created on Jul. 30, 1999 | Created on Feb. 22, | Created on Apr. 5, 2002 |
| | | | 2004 | |

First of all, when the terminal device 20 is initiated by the medical doctor who is the user, the processing unit 23 acquires and initiates an application of the electronic medical record management system stored in the storage device 22 (S1).

Next, when a creation screen of the electronic medical record is requested to the processing unit 23 from the input device 21 by the medical doctor's operation, the creation screen of the electronic medical record is displayed on the display device 25 by direction of the processing unit 23 (S2).

The electronic medical record according to this embodiment has time-line information, and the information for expressing this time-line is displayed on the creation screen beforehand.

In this creation screen of the electronic medical record, first of all, the information of the patient X who is planed the treatment, including age of 3 years old, 15 kg weight, etc., is inputted (S3).

Although the description about the detailed input process of the information, including this age, weight, etc., is omitted, it is inputted as the COA generated by observation as well as the input of the following COA (A) to COA (D).

At this point, first of all, it is important to improve the hypoglycemia accompanying acetonemic vomiting as treatment toward the patient X, in order to alleviate the symptoms, such as headache, abdominal pain, and the emesis of the patient X, and performing applying the treatment of the COA (A) “glucose intravenous injection for improving these symptoms” for 10 minutes is determined by the medical doctor.

In order to input the treatment plan of this COA (A) into the electronic medical record, the acquisition request of the information of COA (A) is inputted into the processing unit 23 by the medical doctor from the input device 21.

When the acquisition request of the information of this COA (A) is inputted, the information of COA (A) is acquired from the COA information storage device 11 by the processing unit 23 through the communication unit 24, the communication unit 13 and the processing unit 15 (S4).

When the information of COA (A) is acquired in the processing unit 23, the acquired information of COA (A) and detailed information of treatment (the concentration of the parenteral solution is 20%, the dose is 40 ml, and administration time is 10 minutes) are inputted on the corresponding treatment execution time on the time-line of the electronic medical record by the medical doctor's operation of the input device 21, other detailed information is generated, and this detailed information is displayed on the display device 25 (S5). The information of these COA (A) and the detailed information of treatment inputted into the electronic medical record and generated are set to COA (A-1).

Based on time-line information, the information of “being prohibition of glucose administration of every 2 hours before and after the self-act” is stored in the linkage act characteristics 121 (A-1) of the inputted COA (A-1).

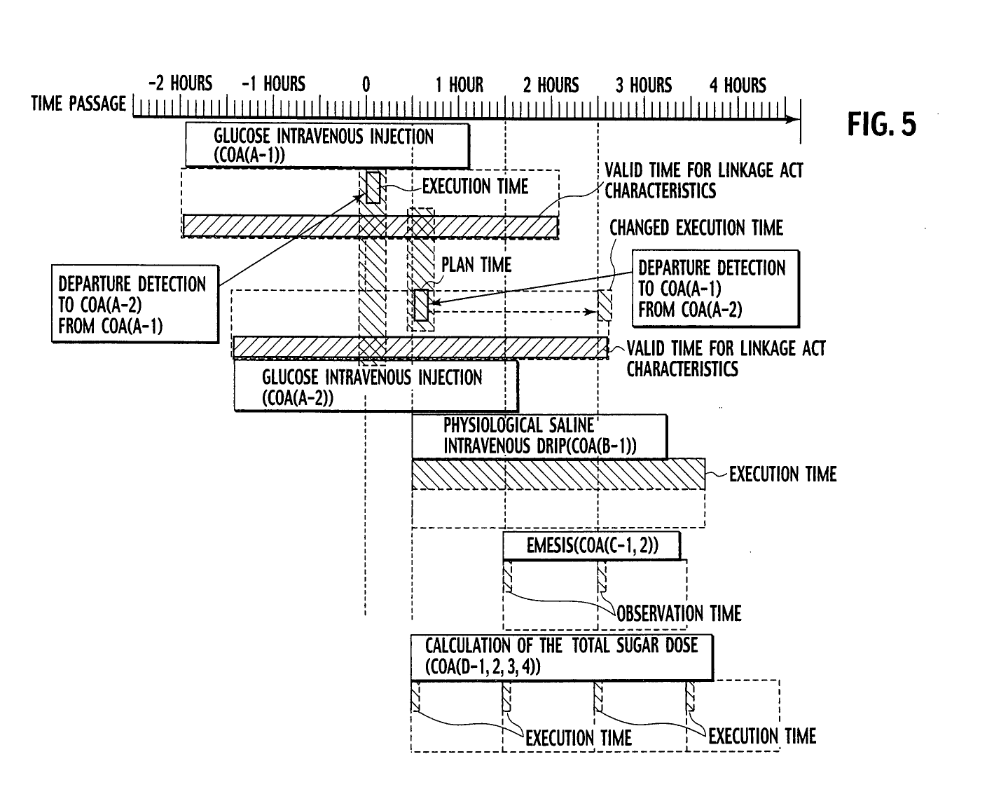

If the time of starting the treatment of COA (A-1) for the information stored in these COA (A-1) is expressed on the time-line as the 0 time, duration from 0 time to 10 minutes constitutes the period of implementation of COA (A-1), and duration from −2 hours to 2 hours becomes constitutes application duration of the linkage act characteristics (A-1), as shown in FIG. 5.

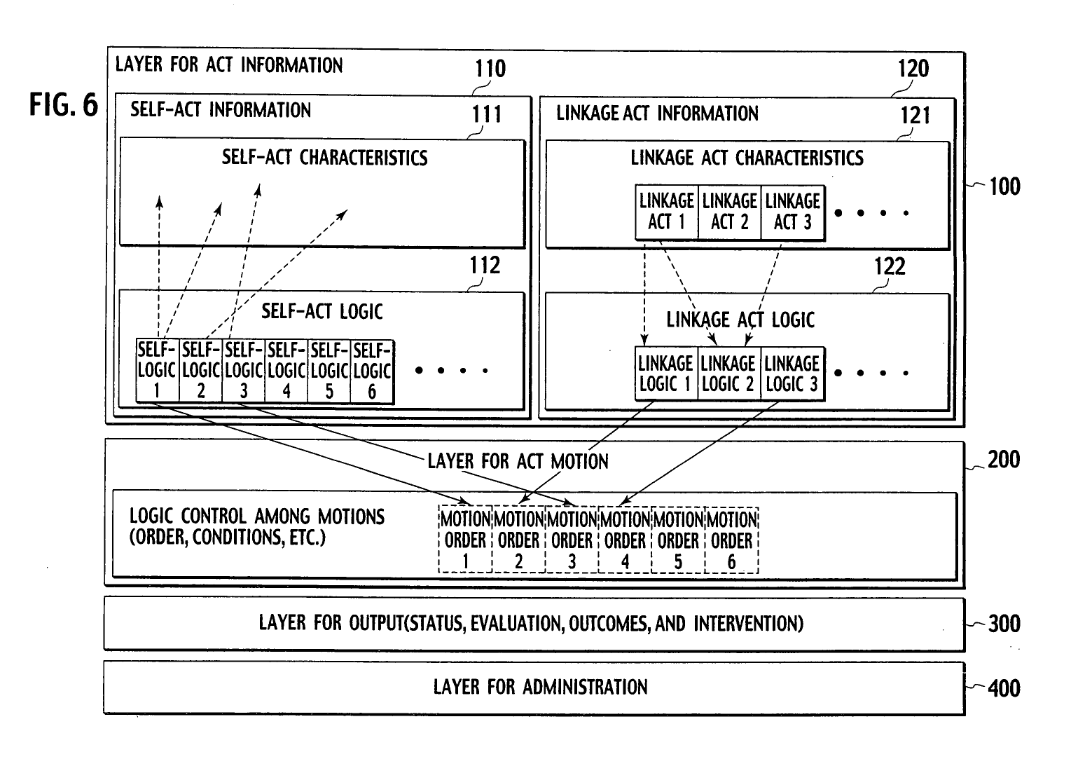

Moreover, when the information whose the concentration of the parenteral solution is 20%, the dose is 40 ml, and the administration time is 10 minutes as the detailed information of the treatment of COA (A-1) is inputted from the input device 21 by the medical doctor's operation, it is determined in the processing unit 23 whether the numerical value of such concentration and the dose is in the appropriate range defined by the knowledge 111d (A-1) of the self-act characteristics 111 (A-1) based on the information stored in the self-act logic 112 (A-1) of COA (A-1), as shown by the dotted line arrow of FIG. 6.

Moreover, although it is determined according to the conditional function of the linkage act logic 122 (A-1) based on the information stored in the linkage act characteristics 121 (A-1) of COA (A-1) whether the input by the existence or nonexistence of contravention of other COA, etc. needs to be updated, since there is no other COA still inputs at this point, the existence or nonexistence of the necessity for updating are supervised in the processing unit 23 from relationship with COA hereinafter inputted by using the information within these linkage act information 120.

The judging process of the self-act logic 112 (A-1) and the linkage act logic 122 (A-1) is performed in the processing unit 23 (S6). The processing order and the processing condition are controlled by the act operation layer 200, according to the characteristics of each self-act information 110 (A-1) or the linkage act information 120 (A-1).

At this point, when it is determined that the numerical value outside the appropriate range is inputted and update of the electronic medical record is needed (in the case of “YES” in S7), warning information is generated as the update process and a pop up screen is displayed on the display device 25 (S8). When it is determined that the numerical value outside the scope is not inputted but there is no necessity for update of the electronic medical record (in the case of “NO” in S7), it shifts to processing of step S9.

Next, when the treatment plan of COA (A-1) is inputted into the electronic medical record, the information, whose COA (A-1) is in plan status, is stored in the status 300a of the layer for output 300 of COA (A-1).

Then, when the treatment of COA (A-1) is performed and a fact which treatment is performed is inputted from the input device 21 by the medical doctor's operation, the information of the status 300a of the layer for output 300 of COA (A-1) is stored with changing from the plan status to the operation status and also to the completion status.

When the status 300a of the layer for output 300 changes to the completion status, evaluations of treatment (the success, failure, etc.) are inputted from the input device 21 by the medical doctor's operation, and are stored in the evaluation 300b (S9).

Next, in order to improve the patient's X dehydration which occurs for the emesis till then improve, starting the treatment which performs “drip-feed solution injection of the physiological saline” of COA (B) over the 3 hours after 30 minutes from the operation start of COA (A-1) is determined by the medical doctor.

In order to further input the treatment plan of this COA (B) into the electronic medical record (in the case of “YES” in S10), it returns to step S4, and the acquisition request of the information on COA (B) is inputted into the processing unit 23 by the medical doctor from the input device 21, and the information of COA (B) is acquired in the processing unit 23 from the COA information storage device 11 through the communication unit 24, the communication unit 13, and the processing unit 15 (S4).

When the information of COA (B) is acquired in the processing unit 23, the acquired information of COA (B) and the detailed information of treatment (the dose of the physiological saline is 10 ml per 1 kg weight, and intravenous drip time is the 3 hours) are inputted and generated by operation of the medical doctor's input device 21 on the time-line of the electronic medical record on the corresponding treatment execution time, and this detailed information is displayed on the display device 25 (S5). The information inputted into these electronic medical records is called to COA (B-1) below.

The information relating to “the simultaneous administration with other transfusion is limited” is stored in the inputted linkage act characteristics 121 (B-1) of COA (B-1) based on the time-line information.

If the time of starting the treatment of COA (A-1) for the information stored in these COA (B-1) is expressed on the time-line as the 0 time, the 3 hours after 30 minute to 3 hour and 30 minutes is the treatment period of COA (B-1), and it becomes the application duration of linkage act characteristics (B), as shown in FIG. 5.

Moreover, when the information whose the dose of the physiological saline is 10 ml per 1 kg weight, and the information, which intravenous drip time is the 3 hours, is inputted from the input device 21 by the medical doctor's operation as the detailed information of the treatment of COA (B-1), it is determined whether the numerical value of these dose and intravenous drip time is in the appropriate range defined by knowledge 111d (B-1) of the self-act characteristics 111 (B-1) based on the information stored in the self-act logic 112 (B-1) of COA (B-1), as shown in the dotted line arrow of FIG. 6, and is determined in the processing unit 23 according to the conditional function of the linkage act logic 122 (B-1) based on the information stored in the linkage act characteristics 121 (B-1) of COA (B-1) whether or not the input by the existence or nonexistence of contravention in other COA, etc. needs to be updated. Moreover, the existence or nonexistence of the necessity for updating is supervised in the processing unit 23 from relationship with COA inputted hereinafter by the information within the linkage act information 120.

The determination process of the self-act logic 112 (B-1) and the linkage act logic 122 (B-1) is executed in the processing unit 23 (S6). The processing order and the processing condition are controlled by the act operation layer 200 according to the characteristics of each self-act information 110 (B-1) or the linkage act information 120 (B-1).

At this point, in the self-act logic 112 (B-1), information of the drugs used under the treatment of COA (B-1) is stored, it calculates and displays that the dose of the physiological saline is 450 ml and the one physiological saline of 500 ml is the needed article in the processing unit 23 from this information, the inputted information whose “dose of the physiological saline is 10 ml per 1 kg weight”, and the information whose “the patient X weighs 15 kg”.

Moreover, when the numerical value outside the appropriate range is inputted, or when it is determined that contravention etc. are detected in the relationship with other COA and the update of the electronic medical record is needed (in the case of “YES” in S7), warning is displayed on the display device 25 in a pop up screen as an update process (S8). When the numerical value outside the scope is not inputted, or when it is determined that contravention in other COA etc. are not detected and there is no necessity for the update of the electronic medical record (in the case of “NO” in S7), it shifts to processing of step S9.

Next, when the treatment plan of COA (B-1) is inputted into the electronic medical record, the information of the status 300a of the layer for output 300 of COA (B-1) is stored as the plan status.

Then, if it is inputted from the input device 21 according to the displayed information by the medical doctor's operation that the medical doctor prepared the one physiological saline of 500 ml, the intravenous drip is started, and treatment is performed, the information of the status 300a of the layer for output 300 of COA (B-1) changes to the operation status from the plan status (S9).

However, since the patient X repeated the emesis and appealed against the stomachache symptom at the time when the intravenous drip is started, treating the “glucose intravenous injection” of COA (A) again is determined by the medical doctor.

In order to further input the treatment plan of this COA (A) into the electronic medical record (in the case of “YES” in S10), it returns to step S4, the information of COA (A) is acquired (S4) by copying the information of COA (A-1) on the electronic medical record already inputted by the medical doctor's operation, input operation is instructed on the corresponding treatment execution time on the time-line, and it is displayed on the display device 25 (S5). This instructed information is set to COA (A-2).

The information of being “prohibition of glucose administration of every 2 hours before and after the self-act” is stored in the linkage act characteristics 121 (A-2) of COA (A-2) that the input is instructed, based on the time-line information.

If the information stored in these COA (A-2) is expressed on the time-line as making the time of starting the treatment of COA (A-1) into the 0 time, duration the 10 minutes after 30 minutes constitutes the treatment period of COA (A-2), and duration from −1 hour and 30 minutes to 2 hour and 30 minutes constitutes the application duration of the linkage act characteristics (A-2), as shown in FIG. 5.

Since it is determined at the time of the input of COA (A-1) whether the information the input is instructed to be is among the appropriate range of knowledge 111d (A-2) of the self-act characteristics 111 (A-2), it is determined in the processing unit 23 based on the information stored in the linkage act characteristics 121 (A-2) of COA (A-2) according to the conditional function of the linkage act logic 122 (A-2) whether the input by the existence or nonexistence of contravention in other COA, etc. needs to be updated (S6).

At this point, the COA (A-1) “glucose intravenous injection” 30 minutes before the treatment start of COA (A-2) is detected as the COA which is contrary to “prohibition of glucose administration of every 2 hours before and after the self-act” stored in the linkage act characteristics 121 (A-2), and it is determined that the update of the electronic medical record is needed (in the case of “YES” in S7).

Moreover, since the contravention in COA (A-1) is supervised in the processing unit 23 simultaneously based on the linkage act logic 122 (A-1) of COA (A-1), it is detected that the COA (A-2) instructed to be inputted is COA which is contrary to COA (A-1), and it is determined that the update of the electronic medical record is needed.

As these detection results, the warning information for notifying that the glucose intravenous injection of COA (A-2) is contrary to the glucose intravenous injection of COA (A-1) as the update process is generated, and it is displayed on the display device 25 in the pop up screen (S8).

By the medical doctor's determination after warning which popped up, the start time of COA (A-2) is changed to the time which has passed for the 2 hours since the drip-feed solution injection start of the physiological saline of COA (B-1), and the input is instructed.

At the time when the 2 hours have passed since this drip-feed solution injection start, since the COA (A-2) is not contrary to COA (A-1), it is determined that the update of the electronic medical record is unnecessary, and warning is not displayed, but it is possible of the input of COA (A-2) at the electronic medical record.

When the treatment plan of COA (A-2) is inputted into the electronic medical record, the status 300a of the layer for output 300 of COA (A-2) is stored with changing into the adjournment status postponed for the 2 hours from the plan status (S9).

Next, in order to grasp the patient's X condition over having performed COA (A-1), COA (B-1), and COA (A-2) so far, observation of the symptom is performed by the medical doctor by determining.

As a result, although the emesis is seen the 60 minutes and 120 minutes after the start of COA (B-1) “drip-feed solution injection of the physiological saline”, it disappeared afterward.

In order to input that there was the emesis into the electronic medical record (in the case of “YES” in S10), it returns to step S4, the acquisition request of the information of COA(C) “emesis” is inputted into the processing unit 23 by the medical doctor from the input device 21, and the information on COA (C) is acquired from the COA information storage device 11 by the processing unit 23 through the communication unit 24, the communication unit 13, and the processing unit 15 (S4).

When the information of COA (C) is acquired by the processing unit 23, by operation of the medical doctor's input device 21, the information of COA (C) and the detailed information of the symptom acquired two the 60 minutes and 120 minutes after the start of “drip-feed solution injection of physiological saline” of the COA (B) on the time-line of the electronic medical record are inputted, and it is displayed on the display device 25 (S5). The information inputted into this electronic medical record is set to COA (C-1) and COA (C-2), respectively.

Next, according to the information of the self-act logic 112, the stage evaluation of the symptom, etc. are calculated from the inputted details of COA (C-1), COA (C-2), and the details of symptom.

Moreover, since the inputted COA (C-1) and COA (C-2) “observation of the symptom (emesis)” are not intervention operation, the information on the linkage act logic 122 is not set up, and since the contravention information is not detected, it is determined that the update of the electronic medical record is unnecessary (in the case of “NO” in S6 and S7).

Moreover, the information of the status 300a of the layer for output 300 of COA (C-1) and COA (C-2) is changed and stored into the already completion status from the operation status (S9).

Furthermore, in order to supervise the glucose administration speed per unit time with observation of the symptom, processing COA (D) “the total sugar dose calculation” once every 1 hour on the electronic medical record is determined by the medical doctor.

In order to input the treatment plan of this COA (D) into the electronic medical record (in the case of “YES” in S10), it returns to step S4, the acquisition request of the information of COA (D) is inputted into the processing unit 23 by the medical doctor from the input device 21, and the information of COA (D) is acquired from the COA information storage device 11 by the processing unit 23 through the communication unit 24, the communication unit 13, and the processing unit 15 (S4).

When the information of COA (D) is acquired by the processing unit 23, the information of COA (D) acquired four times, the 0 minutes, the 1 hour, the 2 hours, and 3 hours after the start of “drip-feed solution injection of physiological saline” of the COA (B) on the time-line of the electronic medical record, is inputted by operation of the medical doctor's input device 21, and it is displayed on the display device 25 (S5). The information inputted into this electronic medical record is called below to COA (D-1), COA (D-2), COA (D-3), and COA (D-4), respectively.

The administration speed, the accumulation dose, and the total caloric content of sugar in every hour are calculated according to this COA (D-1) to COA (D-4) by the processing unit 23, and are displayed on the display device 25.

Since the inputted COA (D-1) to COA (D-4) “the total sugar dose calculation” are not intervention operation, the information of the linkage act logic 122 is not set up. Since the contravention information is not detected, it is determined that the update of the electronic medical record is unnecessary (in the case of “NO” in S6 and S7).

In this embodiment, since the glucose is included in the COA (A-1), COA (A-2) “glucose intravenous injection”, and in the COA (B-1) “drip-feed solution injection of the physiological saline” additionally, the administration speed, the accumulation dose, and the total caloric content by these three COAs are calculated for every hour.

Moreover, the information of the status 300a of the layer for output 300 of COA (D-1) to COA (D-4) is stored as the plan status (S9). When each COA is performed, the information on the status 300a is stored with changing in the operation status from plan status to the completion status.

Moreover, when all the COAs are inputted in the processing unit 23 (in the case of “NO” in S10), the generated electronic medical record data is outputted through the communication unit 24 from the processing unit 23 by the medical doctor's operation, and is recorded on the electronic medical record recording device 12 through the network 30, the communication unit 14, and the processing unit 16 (S11).

According to this above embodiment, when COA is inputted it can be detected with the detailed processing based on time-line information whether the content of treatment is performed for the numerical value in the appropriate range, and whether there is any contravention in other medical actions.

For example, this embodiment, detects the contravention based on the information, including “prohibition of glucose administration of every 2 hours before and after COA (A-1) glucose injection” etc., only the glucose administration inputted at the time of “the 2 hours before and after COA (A-1) glucose injection” is detected as the contravention, and when exceeding the 2 hours, it is not detected as the contravention, but exact processing can be performed according to the detailed information for every medical action.

Moreover, it can read and use also with another terminal device 20 other than the terminal device 20 which created this electronic medical record data with recording electronic medical record data on the electronic medical record recording device 12.

Moreover, the electronic medical record data generated in the processing unit 23 may be recorded on the temporary storage device 26 of the terminal device 20 at the same time it is recorded on the electronic medical record recording device 12. When continuing the treatment toward the patient X in the environment which the terminal device 20 cannot connect to the network 30, it can use the treatment plan of the generated electronic medical record by recording on the temporary storage device 26.

Moreover, when treatment is not performed according to the plan to be inputted on the electronic medical record, warning of the purport that treatment is not performed can be displayed on the display device 25 (even if the injection of COA (A-2) changed after 2 hours in the first embodiment becomes applicable time, the time when the result is not inputted, etc.).

Moreover, in this embodiment, although the information of COA for creating the electronic medical record is acquired from the COA information storage device 11 and used, the existing electronic medical record data currently recorded on the electronic medical record recording device 12 may be used. By using the data of the electronic medical record recording device 12, the treatment plan already created using a plurality of COAs can be referred to.

Moreover, although the alarm display by the contravention in other COA is explained in this embodiment as the update process of the input of the electronic medical record executed with the relationship with other COA, it is not limited to this. The adding processing of other COA executed according to the linkage act characteristic information, the deletion of already inputted COA, or the update process of the electronic medical record information by display development of the relevant screen, etc. may be executed.

Moreover, in this embodiment, although the case where processing of the repetition within the predetermined time is controlled in among the COAs (A) of the same kind is explained, it is possible to detect the existence or nonexistence of the information update by the contravention etc. similarly in among the different COAs.

Moreover, although the case where the contravention relationship among the COAs is detected is explained in this embodiment, it is not limited to this. It is possible to detect all the relationship among the COAs inputted into the electronic medical record including subordinate relationship etc.

Moreover, the information stored in COA shown in the Table 1 and Table 2 of this embodiment is an example of the information shown in order to use for the description.

### <<Electronic Medical Record Management System as a Second Embodiment of Project Management System>>

Another embodiment of the electronic medical record management system will be described as a second embodiment of the project management system of the present invention.

Detailed description is omitted since the configuration of the electronic medical record management system of this embodiment is the same as that of the first embodiment.

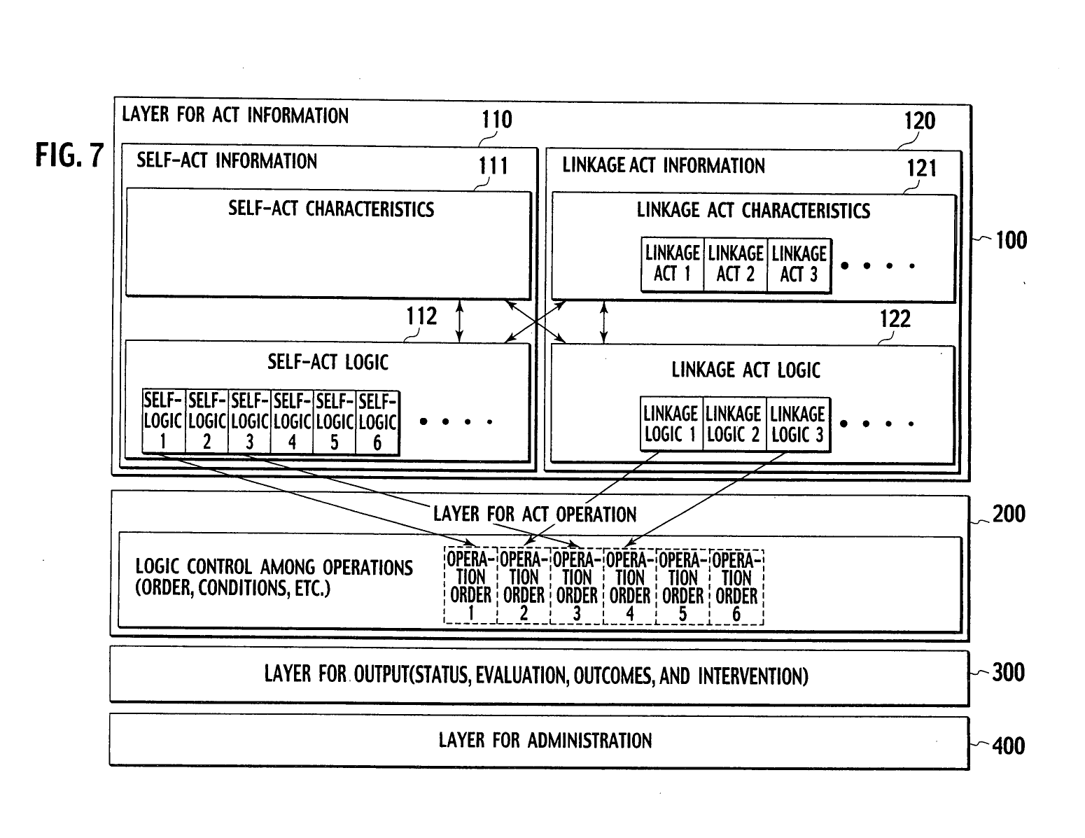

An operation of the electronic chart system 1 in this embodiment will be explained with reference to FIG. 7.

FIG. 7 is an explanatory diagram showing the relationship between the information of COA in this embodiment.

In this embodiment, the information of the “blood test” of COA (K), “gentamicin ointment spreading” of COA (L), and “gentamicin drip-phleboclysis injection” of COA (M) shall be stored in the COA information storage device 11 of the electronic medical record management center device 10.

First of all, the terminal device 20 is initiated by the medical doctor, the application of the electronic medical record management system is initiated, and the information of the electronic medical record of patient Y which is already created and is recorded is acquired by the processing unit 23 from the electronic medical record recording device 12 of the electronic medical record management center device 10 through the network 30.

The electronic medical record acquired by the processing unit 23 is displayed on the display device 25.

At this point, the “blood test” of COA (K) already performed on the previous day and “gentamicin ointment spreading” of COA (L) performed 1 hour ago shall be inputted on the time-line.

In this status, performing COA (M) “gentamicin drip-phleboclysis injection” is determined by the medical doctor, and the information of COA (M) is acquired by the processing unit 23 from the COA information storage device 11.

When the information of COA (M) is acquired by the processing unit 23, the information of COA (M) acquired by the applicable position on the time-line of the electronic medical record is inputted by the medical doctor's operation.

When the COA (M) is inputted, the information is acquired between the COAs inputted into the electronic medical record, and the related COA is detected.

FIG. 7 is the explanatory diagram showing the relationship between the information of COA in this embodiment, and is shown that the information is mutually acquired also among the self-act and the linkage act.

The information of “gentamicin administration prohibition in the within 2 hours before and after the self-act” is stored in the linkage act characteristics of the inputted COA (M), and the information of “gentamicin ointment spreading” of COA (L) performed 1 hour ago based on this information is detected as the related COA.

However, since the medication method of this COA (L) is spreading on the skin, it is determined that it is not necessary to stop execution of “gentamicin drip-phleboclysis injection” of COA (M) by self-act logic, and the display of contravention is not executed.

On the other hand, “prohibition of the administration in the case of renal insufficiency” is stored in the linkage act characteristics of COA (M), and the detection processing of the related COA based on this information is executed.

At this point, since it is determined by the self-act logic of the “blood test” of COA (K) that it is renal insufficiency since it is the 10 times with the normal result value of the serum creatinine inspection in the “blood test” of COA (K) performed on the previous day, the “blood test” of COA (K) determined to be contrary based on the linkage act logic of “gentamicin drip-phleboclysis injection” of COA (M) is detected.

By detecting the “blood test” of COA (K), the warning information for notifying that the “blood test” of COA (K) is contrary to “gentamicin drip-phleboclysis injection” of COA (M) is generated, and is displayed on the display device 25 in the pop up screen.

Thus, the information is mutually acquired among the self-act and the linkage act, the determination is able to be executed by the linkage act based on the result processed and outputted by the self-act, and conversely the determination is able to be executed by the self-act based on the result processed and outputted by the linkage act.

According to this above embodiment, it is detectable by executing the exchange of the information also among the self-act and the linkage act whether the content of treatment is performed for the numerical value in the appropriate range and whether there is any contravention in other medical actions, in still higher precision.

### <<Electronic Medical Record Management System as Third Embodiment of Project Management System>>

As a third embodiment of the project management system of the present invention, the electronic medical record management system which can be executed by combining staff management, accounting management, etc. in the medical field will be explained.

Since the operation of the management about the configuration and medical action of the electronic medical record management system of this embodiment is the same as that of the first embodiment, although the detailed description is omitted, the information of the layer for act information 100 of “nurse assignment” of COA (E) and “accounting implementation” of COA (F) is stored in the COA information storage device 11 of the electronic medical record management center device 10 in this embodiment, in addition to the information on Table 1 in the first embodiment.

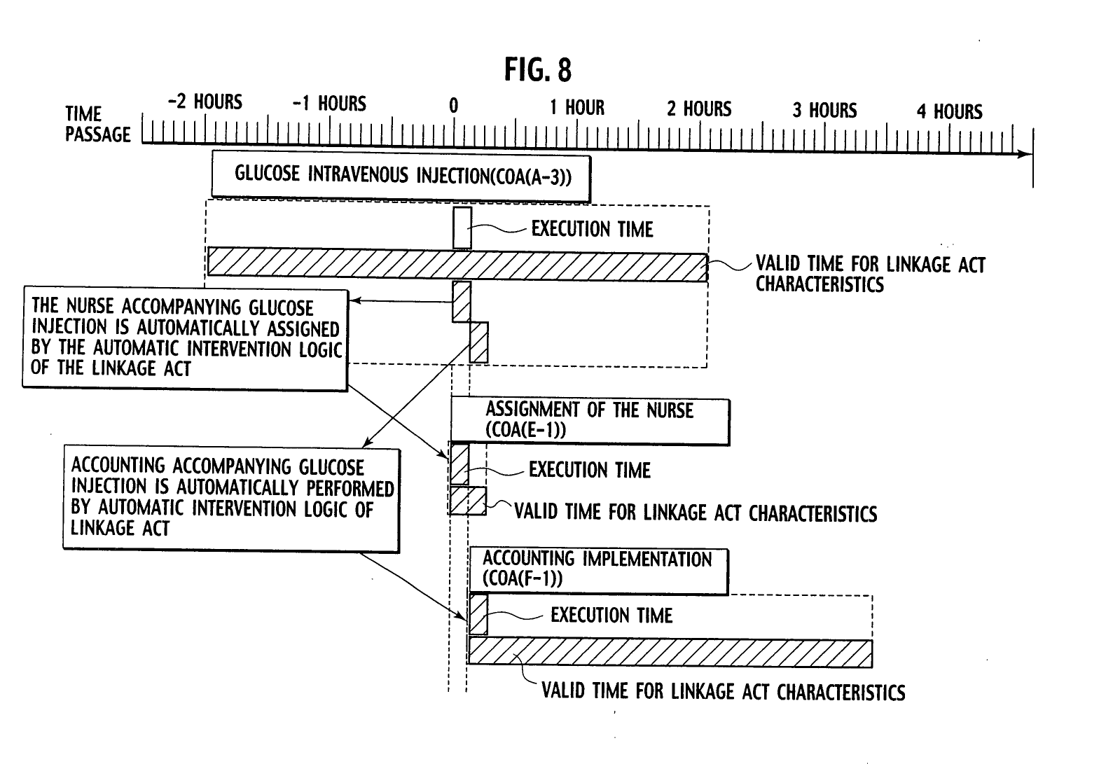

In this embodiment, the operation at the time of executing the staff management and the accounting management will be explained with reference to FIG. 4 and FIG. 8.

In FIG. 4, since the processing of Step S1 to step S4 is the same as that of the first embodiment, detailed description will be omitted.

In step S4, when the information of the “glucose intravenous injection” of COA (A) is acquired from the COA information storage device 11 of the electronic medical record management center device 10 in the processing unit 23 of the terminal device 20, and is inputted on the electronic medical record, the inputted information is displayed on the display device 25 (S5).

The information of COA (A) inputted into the electronic medical record is set to COA (A-3).

In the linkage act characteristics 121 (A-3) of the inputted COA (A-3), the information of “prohibition of glucose administration of every 2 hours before and after the self-act”, the information of “nurse assignment” for implementation of glucose intravenous injection, and the information of “accounting implementation” by implementation of glucose intravenous injection are stored, based on time-line information.

If the time of starting the treatment of COA (A-3) for the information stored in these COA (A-1) is made into the 0 time and expressed on the time-line, duration from 0 time to 10 minutes constitutes the period of implementation of COA (A-3), and duration from −2 hours to 2 hour constitutes application duration of “prohibition of glucose administration of every 2 hours before and after the self-act” of linkage act characteristics (A-3), duration from 0 to 10 minutes constitutes application duration of “nurse arrangement” of linkage act characteristics (A-3), and duration from 10 minutes to 20 minutes constitutes application duration of “accounting implementation” of linkage act characteristics (A-3), as shown in FIG. 8.

Next, it is determined whether or not the input by the relationship with other COA needs to be updated. At this point, since “nurse assignment” and “accounting implementation” which are other acts as the linkage act characteristics 121 (A-3) of COA (A-3) are stored, it is determined that these information is acquired from the COA information storage device 11 of the electronic medical record management center device 10, and it is necessary input into the electronic medical record and to update (in the case of “Yes” in S7).

When it is determined that the update of the electronic medical record is needed in Step S7, the acquisition request of the information of “nurse assignment” of COA (E) and “accounting implementation” of COA (F) is sent to the electronic medical record management center device 10 from the processing unit 23, and the information of COA (E) and COA (F) is acquired from the COA information storage device 11 by the processing unit 23 through the communication unit 24, the communication unit 13, and the processing unit 15.

When the information of COA (E) and COA (F) is acquired by the processing unit 23, it is inputted into the applicable time position on the electronic medical record according to the information of the linkage act characteristics 121 (A-3).

The information of COA (E) inputted into the electronic medical record is set to COA (E-1), and the information of COA (F) is set to COA (F-1).

The linkage act characteristics 121 (E-1) are further stored in the inputted COA (E-1) and COA (F-1) if needed.

Thus, the electronic medical record is updated by acquiring and inputted automatically the information of COA (E-1) and COA (F-1), based on the linkage act characteristics 112 (A-3) (S8).

Detailed description is omitted since the processing after step S9 is the same as that of the first embodiment.

According to the electronic medical record management system of the above third embodiment, not only the medical action itself but also the various acts generated by implementation of the medical action can be managed based on the time-line information, and the various acts in the medical site can be processed efficiently.

According to this embodiment, it becomes possible to perform staff assignment and accounting management by the electronic medical record by automatically the staff who is needed by implementation of the medical action, or accounting processing simultaneously with complete of implementation of the medical action.

Moreover, although the nurse assignment and the accounting implementation are explained as the act generated by implementation of the medical action in this embodiment, it is not limited to this. It is also possible to manage procurement of supplies and equipment, use management of the institutions, etc.

### <<Fabricating Process Management System as Fourth Embodiment of Project Management System>>

A fabricating process management system for managing a fabricating process in an industrial commodity fabricating field as a fourth embodiment of the project management system of the present invention will be explained.

The definition of the act and COA in the fabricating process management system of this embodiment is the same as that of the first embodiment, there is “fabricating”, “assembly”, “ocular inspection”, and etc. as an example of the act, and the detailed information about these is stored as the COA.

### <Configuration of Fabricating Process Management System as Fourth Embodiment>

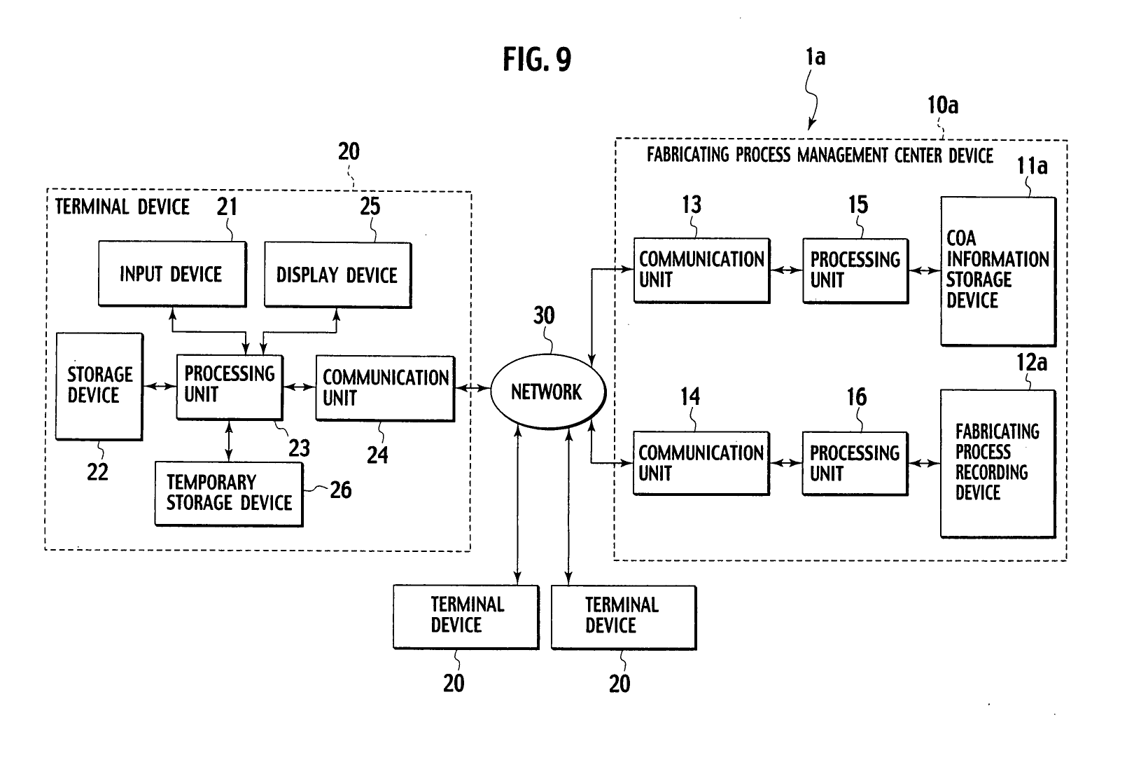

A configuration of a fabricating process management system 1a in this embodiment will be explained with reference to FIG. 9.

The fabricating process management system 1a in this embodiment is comprised by connecting a fabricating process management center device 10a and a plurality of terminal devices 20 through a network 30.

The fabricating process management center device 10a omits detailed description, since everything but replacing the electronic medical record recording device 12 of the electronic medical record management center device 10a of the first embodiment, composing the fabricating process recording devices 12a, is the same as that of the configuration of the electronic medical record management center device of the first embodiment.

In this embodiment, the COA about the acts, such as “fabricating”, “assembly”, and “ocular inspection”, is stored in a COA information storage device 11a, and the data generated as a fabricating process using the COA is stored in a fabricating process recording device 12a.

Moreover, detailed description is omitted since the information which comprises each COA is the same as that of the first embodiment.

Moreover, detailed description is omitted since the terminal device 20 is the same as that of the configuration of the terminal device 20 of the first embodiment.

### <Operation of Fabricating Process Management System as Fourth Embodiment>

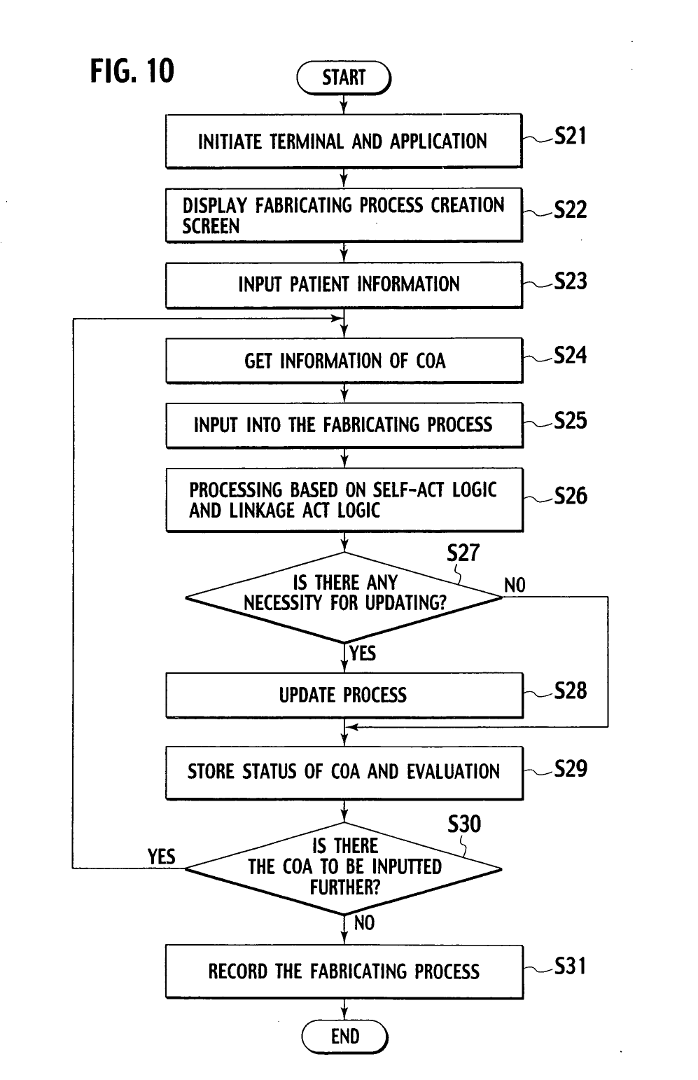

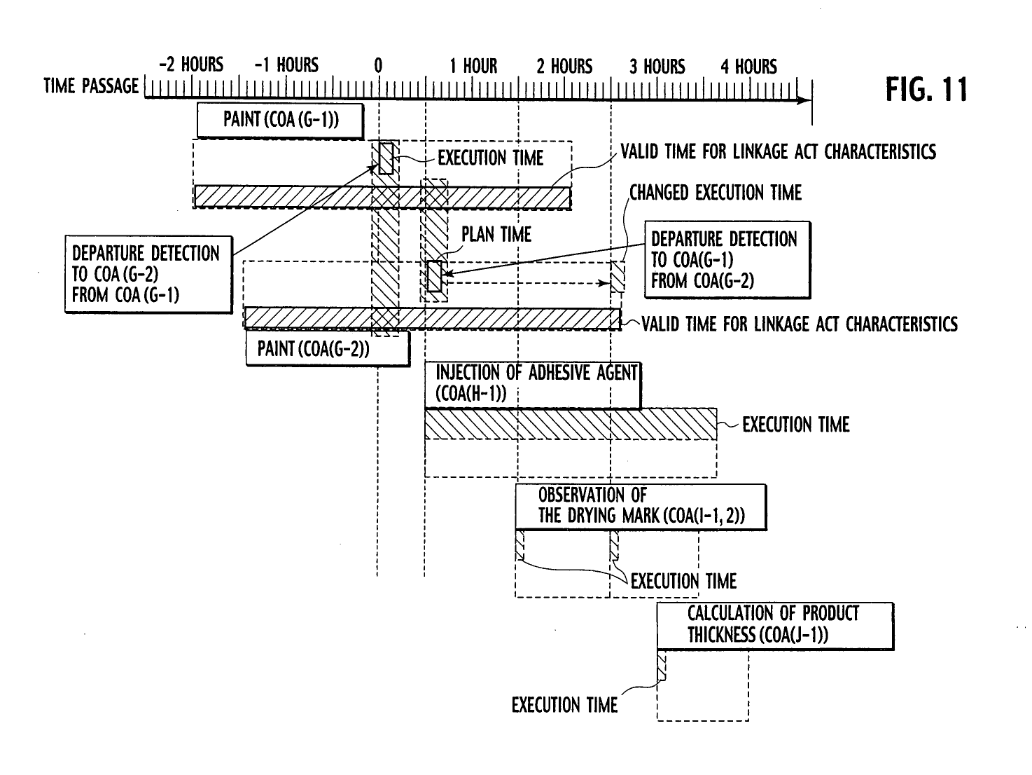

Hereinafter, an operation of the fabricating process management system 1a as the fourth embodiment will be explained in detail with reference to FIG. 10 and FIG. 11 using an example.

This embodiment explains an operation of the fabricating process management system 1 at the time of generating the painting process plan during industrial commodity fabricating to the example.

In this embodiment, correspond to create the painting process plan, information of COA (G), COA (H), COA(I), and COA (J) of the layer for act information 100 is stored as shown in Table 3, and information of the layer for administration 400 is beforehand stored as shown in Table 4, in the COA information storage device 11 of the fabricating process management center device 10a.

As for each information stored in these COA(s), the self-act information of COA (G) is expressed as the self-act information 110 (E), the linkage act information is expressed as the linkage act information 120 (E), . . . , the self-act information of COA (H) is expressed as the self-act information 110 (F), and linkage act information is expressed as the linkage act information 120 (F), respectively.

TABLE 3

| | | | |
|---|---|---|---|
| COA (G) | COA (H) | COA (I) | COA (J) |

(1) Act information layer 100
(i) Self-act 110

| | | | | | |
|---|---|---|---|---|---|
| Self-act | Title 111a | Paint | Injection of adhesive | Observation of paint | Calculation of product |
| characteristics 111 | | | agent | unevenness | thickness |
| | Classification 111b | Intervention operation | Intervention operation | Observation operation | Logic operation |
| | | (Paint) | (Assembly) | (Ocular inspection) | (Assay) |
| | Relevant ID 111c | I-00001 | D-00001 | O-00001 | L-00001 |
| | Knowledge 111d | | | | |

| | | | | |
|---|---|---|---|---|
| Self-act logic 112 | Nothing | Nothing | Calculation method of the | Add the thickness of the |
| | | | number of the | product itself to the |
| | | | unevenness per unit area, | number of times of |
| | | | etc. | coating thickness × per |
| | | | | time |

(ii) Linkage act 120

| | | | | |
|---|---|---|---|---|
| Linkage act characteristics 121 | Two coats for the second | Nothing | Nothing | |
| | time is forbidden after the | | | |
| | paint for the 2 hours | | | |
| Linkage act logic 122 | [Conditional function] | [Conditional function | [Conditional function] | [Conditional function] |

TABLE 4

| | COA (G) | COA (H) | COA (I) | COA (J) |
|---|---|---|---|---|
| Management title 400a | Paint | Assembly | Inspection | Assay |
| Management ID 400b | X0001A001 | X0001B001 | S0001A001 | R0001A001 |
| Copyright 400c | Company A | Company A | Engineer B | Publishing company C |
| Version information 400d | The 3^{rd} edition | The 5^{th} edition | The 3^{rd} edition | The 1^{st} edition |
| | Created on Mar. 2, 2004 | Created on Jul. 30, 1999 | Created on Feb. 22, | Created on Apr. 5, 2002 |
| | | | 2004 | |

First of all, when the terminal device 20 is initiated by an user, an application of the fabricating process management system stored in the storage device 22 is acquired and initiated by the processing unit 23 (S21).

Next, when a creation screen of a fabricating process timetable is requested to the processing unit 23 from the input device 21 by the user's operation, the creation screen of the fabricating process timetable is displayed on the display device 25 by direction of the processing unit 23 (S22).

The fabricating process timetable by this embodiment has time-line information, and information for expressing this time-line beforehand is displayed in the creation screen.

In this fabricating process creation table, first of all, creating the plan about the step of the paint is inputted (S23).

First of all, performing applying the processing of COA (G) “paint” for the first outside paint for the 10 minutes is determined by the user.

In order to input the processing of this COA (G) into the fabricating process timetable, the acquisition request of the information of COA (G) is inputted into the processing unit 23 by the user from the input device 21, and the information on COA (G) is acquired by the processing unit 23 from the COA information storage device 11 through the communication unit 24, the communication unit 13, and the processing unit 15 (S24).

If the information of COA (G) is acquired by the processing unit 23, the information of the acquired COA (G) is inputted into the corresponding position on the time-line of the fabricating process timetable by operation of the user's input device 21, and is displayed on the display device 25 (S25). The information of this COA (G) inputted into the fabricating process timetable is set to COA (G-1).

Based on time-line information, the information of “prohibition of next coat after the paint for the 2 hours” is stored in the linkage act characteristics 121 (E-1) of inputted COA (G-1).

If the time of starting processing of COA (G-1) for the information stored in this COA (G-1) is made into the 0 time and expressed on the time-line, duration from 0 time to 10 minutes constitutes the period of implementation of COA (G-1), and duration from −2 hours to 2 hours constitutes application duration of the linkage act characteristics (E-1), as shown in FIG. 11.

Moreover, when the self-act logic 112 is stored in the inputted COA, processing of the identification, the operation, etc. of the information of the self-act characteristics 111 is executed in the processing unit 23 based on the information stored in this self-act logic 112, as shown in the dotted line arrow of FIG. 6.

At this point, the processing is not executed since the information is not stored in the self-act logic 112 (E-1).

Moreover, although it is determined according to the conditional function of the linkage act logic 122 (E-1) based on the information stored in the linkage act characteristics 121 (E-1) of COA (G-1) whether or not the input information by the existence or nonexistence of contravention with other COA, etc. needs to be updated, since there is no COA still inputted into others at this point, the existence or nonexistence of the necessity for updating are supervised by the processing unit 23 from the relationship with COA hereinafter inputted using the information within these linkage act information 120.

The determination process of the self-act logic 112 (E-1) and the linkage act logic 122 (E-1) is controlled the processing order and the processing condition, and is executed by the processing unit 23, by the act operation layer 200 by the characteristics of each self-act information 110 (E-1) or the linkage act information 120 (E-1) (S26).

At this point, when there is the necessity for warning by the identification, the operation, and processing of determining of the existence or nonexistence of the contravention (in the case of “YES” in S27), warning is displayed on the display device 25 in the pop up screen (S28). When there is no necessity for warning (in the case of “NO” in S27), it shifts to processing of Step S29.

Next, when the processing plan of COA (G-1) is inputted into the fabricating process, the information whose COA (G-1) is in plan status is stored in the status 300a of the layer for output 300 of COA (G-1).

Then, when the processing of COA (G-1) is performed and it is inputted from the input device 21 that the processing is performed by the user's operation, the information on the status 300a of the layer for output 300 of COA (G-1) is changed to the operation status from the plan status and also to the completion status, and stored.

When the status 300a of the layer for output 300 changes to the completion status, the evaluations (the success, failure, etc.) of processing are inputted from the input device 21 by the user's operation, and are stored in the evaluation 300b (S29).

Next, starting the processing which performs COA (H) “adhesive agent injection” over the 3 hours 30 minutes after the operation start of COA (G-1) is determined by the user.

In order to input the processing plan of this COA (H) further into the fabricating process (in the case of “YES” in S30), it returns to Step S24, the acquisition request of the information on COA (H) is inputted into the processing unit 23 by the user from the input device 21, and the information of COA (H) is acquired by the processing unit 23 from the COA information storage device 11 through the communication unit 24, the communication unit 13, and the processing unit 15 (S24).

When the information of COA (H) is acquired by the processing unit 23, the information of the acquired COA (H) is inputted on the corresponding processing execution time on the time-line of the fabricating process by operation of the user's input device 21, and is displayed on the display device 25 (S25). The information inputted into this fabricating process is set to COA (H-1).

Since the information is not stored in the inputted self-act logic 112 (F-1) and the linkage act characteristics 121 (F-1) of COA (H-1), the processing based on these (S26) and the processing about warning (S27, S28) is not executed.

If the time of starting processing of COA (G-1) for the information stored in this COA (H-1) is made into the 0 time and expressed on the time-line, duration the 3 hours after 30 minutes to 3 hours and 30 minutes is constitute the processing period of COA (H-1), as shown in FIG. 11.

Next, when the processing plan of COA (H-1) is inputted into the fabricating process, the information of the status 300a of the layer for output 300 of COA (H-1) is stored as the plan status.

Then, when the adhesive agent injection is performed by the user and having performed is inputted according to the displayed information, the information on the status 300a of the layer for output 300 of COA (H-1) changes to the operation status from the plan status (S29).

Next, processing second COA (G) “paint” is determined by the user.

In order to input the processing plan of this COA (G) further into the fabricating process (in the case of “YES” in S30), it returns to Step S24, the information on COA (G) is acquired (S24) by copying the information of COA (G-1) on the fabricating process already inputted by the user's operation, and the input is instructed in the position simultaneous with the start of “the adhesive agent injection” of COA (H-1) on the time-line (S25). This input is set to COA (G-2).

The information of “prohibition the two coats for the second time after the paint for the 2 hours” is stored in the linkage act characteristics 121 (E-2) of COA (G-2) that the input is instructed, based on time-line information.

If the time of starting processing of COA (G-1) for the information stored in these COAs (G-2) is made into the 0 time and expressed on the time-line, duration the 10 minutes after the 30 minutes constitutes the processing term of COA (G-2), and the duration from −1 hour and 30 minutes to 2 hours and 30 minutes constitutes application duration of the linkage act characteristics (E-2), as shown in FIG. 11.

Since it is determined at the time of the input of COA (G-1) whether the information that the input is instructed to be is in the appropriate range of the knowledge 111d (E-2) of the self-act characteristics 111 (E-2), it is determined in the processing unit 23 based on the information stored in the linkage act characteristics 121 (E-2) of COA (G-2) according to the conditional function of the linkage act logic 122 (E-2) whether the input by the existence or nonexistence of the contravention in other COAs, etc. needs to be updated (S26).

At this point, the “paint” of COA (G-1) 30 minutes before the processing start of COA (G-2) is detected as the COA which is contrary to the “prohibition the two coats for the second time after the paint for the 2 hours” stored in the linkage act characteristics 121 (E-2) (in the case of “YES” in S27).

Moreover, simultaneously, since the contravention in COA (G-1) is supervised by the processing unit 23 based on the linkage act logic 122 (E-1) of COA (G-1), it is detected that the inputted COA (G-2) is COA which is contrary to COA (G-1).

As these detection results, the warning information for notifying that the paint of COA (G-2) is contrary to the paint of COA (G-1) is generated, and is displayed on the display device 25 in the pop up screen (S28).

By the warning which popped up, the start time of COA (G-2) is changed to the time which passes since the adhesive agent injection of COA (H-1) for the 2 hours by the user determining, and the reentry is instructed.

When the 2 hours passes since this adhesive agent injection start, since COA (G-2) is not contrary to COA (G-1), the warning is not displayed, but it is possible of the input of COA (G-2) to the fabricating process.

When the processing plan of COA (G-2) is inputted into the fabricating process, the status 300a of the layer for output 300 of COA (G-2) is changed and stored into the adjournment status adjourned for the 2 hours from plan status (S29).

Next, in order to calculate the number of an unevenness generated by performing the medical actions COA (G-1), COA (H-1), and COA (G-2) so far, the observation is performed at 1 hour and 30 minutes, and 2 hours and 30 minutes after the start of COA (G-1) the “paint”.

In order to input that observation is executed into the fabricating process (in the case of “YES” in S30), it returns to Step S24, the acquisition request of the information of COA (I) “paint unevenness observation” is inputted into the processing unit 23 by the user from the input device 21, and the information of COA(I) is acquired by the processing unit 23 from the COA information storage device 11 through the communication unit 24, the communication unit 13, and the processing unit 15 (S24).

When the information of COA (I) is acquired by the processing unit 23, the information of COA (I) acquired by two of the 1 hour and 30 minutes and the 2 hours and 30 minutes after the start of COA (G-1) the “paint” on the time-line of the fabricating process by operation of the user's input device 21, and an observation results, such as the observed size and the number of the unevenness calculated by observation, are inputted, and is displayed on the display device 25 (S25). The information inputted into this fabricating process is set to COA (I-1) and COA (I-2), respectively.

Next, according to the information of the self-act logic 112 (G-1) and (G-2), the number of the unevenness per unit area is calculated from inputted COA (I-1), COA (I-2), and the observation result.

Since COA (I-1) and COA (I-2) “paint unevenness observation” which are inputted are not intervention operation, the information of the linkage act logic 122 is not set up, and the contravention information is not detected (in the case of “NO” in S26 and S27).

Moreover, the information of the status 300a of the layer for output 300 of COA (I-1) and COA (I-2) is changed and stored into the already completion status from the operation status (S29).

Furthermore, executing “product thickness calculation” processing of COA (J) for calculating the thickness of the product after the paint with the paint unevenness observation is determined by the user.

In order to input the processing plan of this COA (J) into the fabricating process (in the case of “YES” in S30), it returns to Step S24, the acquisition request of the information of COA (J) is inputted into the processing unit 23 by the user from the input device 21, and the information of COA (J) is acquired by the processing unit 23 from the COA information storage device 11 through the communication unit 24, the communication unit 13, and the processing unit 15 (S24).

When the information of COA (J) is acquired by the processing unit 23, the information of COA (J) acquired 3 hours after the start of COA (G-1) the “paint” on the time-line of the fabricating process is inputted, and is displayed on the display device 25 by operation of the user's input device 21 (S25). The information inputted into this fabricating process is set to COA (J-1).

From this inputted COA (J-1), processing for calculates the product thickness by adding the thickness of the product itself to the coat thickness×the number of times of paint per paint is executed in the processing unit 23 according to the information on the self-act logic 112 (H-1), and is displayed on the display device 25.

Moreover, since the inputted COA (J-1) “product thickness calculation” is not intervention operation, the information of the linkage act logic 122 is not set up, and the contravention information is not detected (in the case of “NO” in S26 and S27).

In this embodiment, as for the paint, since COA (G-1) and COA (G-2) are performed twice, the product thickness by execution of COA of these twice is calculated.

Moreover, the information of the status 300a of the layer for output 300 of COA (J-1) is stored as the plan status (S29). When this COA (J-1) is performed, the information of the status 300a changes to the operation status from plan status, and is changed and stored into the completion status.

Moreover, when all the COAs are inputted in the processing unit 23 (in the case of “NO” in S30), the generated fabricating process data is recorded on the fabricating process recording device 12 by the user's operation through the communication unit 24, the communication unit 14, and the processing unit 16 (S31).

According to this above embodiment, when COA is inputted, it can be detected by the detailed processing based on time information whether the content of processing is performed for the numerical value in the appropriate range, and whether there is any contravention in other processing.

Moreover, it can read and use also with another terminal device 20 other than the terminal device 20 which created this fabricating process data, by recording the fabricating process data on the fabricating process recording device 12.

Moreover, the fabricating process data generated in the processing unit 23 may be recorded on the temporary storage device 26 of the terminal device 20 at the same time of recording on the fabricating process recording device 12, and also when performing paint processing in the environment which the terminal device 20 cannot connect to the network 30, it can perform using the processing plan of the generated fabricating process by recording on the temporary storage device 26.

Moreover, when the processing is not performed according to the plan inputted on the fabricating process (even when the paint of COA (G-2) changed after 2 hours in the fourth embodiment becomes applicable time, when the result is not inputted, etc.), the warning of the purport that the processing is not performed can be displayed on the display device 25.

Moreover, in this embodiment, although the information of COA for creating the fabricating process is acquired and used from the COA information storage device 11, the existing fabricating process data currently recorded on the fabricating process recording device 12 may be used. By using the data of the fabricating process recording device 12, the processing plan already created using a plurality of COAs can be referred to.

Moreover, by programming the functional constitution of the electronic medical record management center device of the electronic medical record management system of the above-mentioned first embodiment and the third embodiment, or the fabricating process management center device of the fabricating process management system of the fourth embodiment, and incorporating in a computer, it is also possible to build the project management center device program as which the concerned computer is operated as the electronic medical record management center device of the electronic medical record management system or a fabricating process management center device of the fabricating process management system.

Moreover, by programming the functional constitution of the terminal device of the electronic medical record management system of the above-mentioned first embodiment and the third embodiment, or the terminal device of the fabricating process management system of the fourth embodiment, and incorporating in the computer, it is also possible to build the terminal device program as which the concerned computer is operated as the terminal device of the electronic medical record management system or a terminal device of the fabricating process management system.

In addition, although the processing unit 23, the storage device 22, the communication unit 24, and the temporary storage device 26 of the terminal device in the first, the second, and the third embodiments are not necessarily limited to this, they may be comprised by the PC (Personal Computer) such as previous statement. In this case, by creating a program which makes PC execute the mechanism (for example, Step shown in S4 to S10, etc.) in which the processing unit 23, the storage device 22, the communication unit 24, and the temporary storage device 26 execute, and running this program on the PC, it is possible to execute project management etc. which are operation of the present invention.

Moreover, it cannot be overemphasized that it may download the program to PC by using CD (CD-RW, CD-R) recorded beforehand such the program. The recording medium is not limited to CD, and the optical disc of other kinds (for example, DVD (Digital Video Disc), a magnetic disk, a magnetic tape, an optical tape, a semiconductor memory, a card shape hard disk, etc.) may be sufficient.

### INDUSTRIAL APPLICABILITY

The present invention may be used by the various fields of industry including the medical service or the extractive industry. Specifically, according to the present invention, the efficiency of building and managing the various projects in the various fields of industry is increased.

1. A project management system for managing act information in a project on time-line, the project management system comprising:
an act information storage unit configured to store a plurality of act information which includes at least linkage information which comprises an applicable condition for an own act and other acts to have a relevance for the every performed act;
an act information acquiring unit configured to acquire the act information which is selected from the plurality of act information stored in the act information storage unit;
an act information arrangement unit configured to arrange the act information on the time-line information based on direction from the outside, respectively, wherein the act information has time-line information and the act information is acquired by the act information acquiring unit;
an act information detecting unit configured to detect mutually other act information to which the linkage information included in the concerned act information is applied, among the act information arranged by the act information arrangement unit on the time-line information; and
an output information generation unit configured to output information is generated based on a resulting detection processing in the act information detecting unit.

2. The project management system according to claim 1, wherein:
the act information stored in the act information storage unit further includes self-act information which comprises self-act characteristic information and self-act logic information, wherein the self-act characteristic information comprises information about characteristics of the act itself, wherein the self-act logic information comprises an applicable condition for processing generated based on this self-act characteristic information; and
the output information generation unit generates the output information based on the self-act characteristic information, when the applicable condition of the self-act logic information of the act information arranged on the time-line information is applied.

3. The project management system according to claim 1 or 2, wherein:
the act information stored in the act information storage unit further includes generation control information to control generation order and generation conditions at the time of the output information being generated in the output information generation unit; and
the output information processing unit executes the generation processing on the generation order and generation conditions, wherein the generation order and generation conditions are controlled based on the generation processing control information.

4. The project management system according to any one of claims 1 to 3, wherein
contents of the output information generation processing in the output information processing unit include at least one of adding of information on other acts, deletion of information on the act already arranged, generation of warning information, and generation of pertinent information inspection screen.

5. The project management system according to any one of claims 1 to 4, wherein
the act in the project is at least one of a medical action, a staff management action, needed procurement-of-supplies-and-equipment act, and accounting implementation act.

6. A project management center device for managing information about an act performed in a project, the project management center device comprising:
an act information storage unit configured to store a plurality of act information which includes at least linkage information which comprises an applicable condition for an own act and other acts to have a relevance for every performed act; and
a project information record unit configured to store project information created with arranging the act information on time-line information.

7. The project management center device according to claim 6, wherein
the act information stored in the act information storage unit further includes self-act information which comprises self-act characteristic information and self-act logic information, wherein the self-act characteristic information comprises information about characteristics of the act itself, wherein the self-act logic information comprises an applicable condition for processing generated based on this self-act characteristic information.

8. The project management center device according to claim 6, wherein
the act information stored in the act information storage unit further includes generation processing control information to control generation order and generation conditions of a plurality of output information, wherein the output information includes at least one of output information generated based on a result from which other act information to which the linkage information is applied is detected among the act information arranged at the time-line information, and output information generated based on the self-act characteristic information when an applicable condition of the self-act logic information of the act information arranged at the time-line information is applied.

9. A terminal device connected to a project management center device for managing project information about an act performed in a project through a network, the terminal device being used by a user, the terminal device comprising:
an act information acquiring unit configured to acquire selected act information through the network from a plurality of act information, wherein the plurality of act information is stored on the project management center device and includes at least linkage information which comprises applicable conditions for an own act and other acts to have a relevance for every performed act;
an act information arrangement unit configured to arrange the act information on the time-line information based on direction from the outside, respectively, wherein the act information has time-line information and the act information is acquired by the act information acquiring unit;
an act information detecting unit configured to detect mutually other act information to which the linkage information included in the act information is applied, among the concerned act information arranged by the act information arrangement unit on the time-line information; and
an output information generation unit configured to output information is generated based on a resulting detection processing in the act information detecting unit.

10. The terminal device according to claim 9, wherein:
the act information acquired by the act information acquiring unit further includes self-act information which comprises self-act characteristic information and self-act logic information, wherein the self-act characteristic information comprises information about characteristics of the act itself, wherein the self-act logic information comprises an applicable condition for processing generated based on this self-act characteristic information; and
the output information generation unit generates the output information based on the self-act characteristic information, when the applicable condition of the self-act logic information of the act information arranged on the time-line information is applied.

11. The terminal device according to claim 9 or 10, wherein:
the act information acquired in the act information acquiring unit further includes generation control information to control generation order and generation conditions at the time of the output information being generated in the output information generation unit; and
the output information processing unit executes the generation processing on the generation order and generation conditions, wherein the generation order and generation conditions are controlled based on the generation processing control information.

12. The terminal device according to any one of claims 9 to 11, wherein
contents of the output information generation processing in the output information processing unit include at least one of adding of information on other acts, deletion of information on the act already arranged, generation of warning information, and generation of pertinent information inspection screen.

13. The terminal device according to any one of claims 9 to 12, wherein
the act in the project is at least one of a medical action, a staff management action, needed procurement-of-supplies-and-equipment act, and accounting implementation act.

14. The terminal device according to any one of claims 9 to 13, further comprising
a temporary storage unit configured to store project information which the act information is arranged and is comprised on the time-line information.

15. A project management center device program for achieving a plurality of functions to a project management center device for managing project information about an act performed in a project, the program comprising:
an act information memory function for storing a plurality of act information which includes at least linkage information which comprises an applicable conditions for an own act and other acts to have a relevance for every performed act; and
a project storing function for storing the project information created with arranging the act information on the time-line.

16. A terminal device program for achieving a plurality of functions to a terminal device connected to a project management center device for managing information of an act performed in a project through a network, the terminal device is used by a user, the program comprising:
an act information acquisition function for acquiring selected act information through the network from a plurality of act information, wherein the plurality of act information is stored on the project management center device and includes at least linkage information which comprises applicable conditions for an own act and other acts to have a relevance for every performed act;
an act information arrangement function for arranging the act information on the time-ling information based on direction from the outside, respectively, wherein the act information has time-line information and the act information is acquired by the act information acquisition function;
an act information detection function for detecting mutually other act information to which the linkage information included in the concerned act information is applied among the act information arranged by the information arrangement function on the time-line information; and
an output information generation function for generating output information based on a resulting detection processing by the act information detection function.

17. The terminal device program according to claim 16, wherein:
the act information acquired by the act information acquiring function further includes self-act information which comprises self-act characteristic information and self-act logic information, wherein the self-act characteristic information comprises information about characteristics of the act itself, wherein the self-act logic information comprises an applicable condition for processing generated based on this self-act characteristic information; and
the output information generation function generates the output information based on the self-act characteristic information, when the applicable condition of the self-act logic information of the act information arranged on the time-line information is applied.

18. The terminal device program according to claim 16 or 17, wherein:
the act information acquired in the act information acquiring function further includes generation control information to control generation order and generation conditions at the time of the output information being generated in the output information generation function; and
the output information processing function executes the generation processing on the generation order and generation conditions, wherein the generation order and generation conditions are controlled based on the generation processing control information.

19. The terminal device program according to any one of claims 16 to 18, wherein
contents of the output information generation processing in the output information processing function include at least one of adding of information on other acts, deletion of information on the act already arranged, generation of warning information, and generation of pertinent information inspection screen.

20. The terminal device program according to any one of claims 16 to 19, wherein
the act in the project is at least one of a medical action, a staff management action, needed procurement-of-supplies-and-equipment act, and accounting implementation act.

21. The terminal device program according to any one of claims 16 to 20, further comprising
a temporary storage function configured to store project information which the act information is arranged and is comprised on the time-line information.

22. An electronic medical record management system for managing information about a medical action on time-line, the electronic medical record management system comprising:
a medical action information storage unit configured to store a plurality of medical action information which includes at least linkage information which comprises applicable conditions for an own medical action and other medical actions to have a relevance is recorded for every medical action;
a medical action information acquisition unit configured to acquire the medical action information which is selected from a plurality of the medical action information stored in the medical action information storage unit;
a medical action arrangement unit configured to arrange the medical action information on the time-axis information based on direction from the outside, respectively, wherein the act information has time-line information and the act information is acquired by the medical action information acquisition unit;
a medical action information detecting unit configured to detect mutually other medical action information that the linkage information included in the concerned medical action information is applied, among the medical action information arranged by the medical action arrangement unit on the time-line information; and
an output information generation unit configured to output information is generated based on a resulting detection processing in the medical action information detecting unit.
